(19) United States
(12) Patent Application Publication
(10) Pub. No.: US 2020/0226671 A1
(43) Pub. Date: Jul. 16, 2020

(54) METHOD AND ELECTRONIC DEVICE FOR DISPLAYING AT LEAST ONE VISUAL OBJECT

(71) Applicant: Samsung Electronics Co., Ltd., Gyeonggi-do (KR)

(72) Inventors: Sangmin SHIN, Gyeonggi-do (KR); Ohyoon KWON, Gyeonggi-do (KR); Deokgyoon YOON, Gyeonggi-do (KR); Jiwoo LEE, Gyeonggi-do (KR)

(21) Appl. No.: 16/739,209

(22) Filed: Jan. 10, 2020

(30) Foreign Application Priority Data
Jan. 10, 2019 (KR) 10-2019-0003427

(51) Int. Cl. G06Q 30/06; G06F 3/16; G10L 15/22; G06K 9/00

(52) U.S. Cl. CPC G06Q 30/0643; G06Q 30/0625; G10L 2015/223; G10L 15/22; G06K 9/00671; G06F 3/167

(57) ABSTRACT

According to certain embodiments, an electronic device may include a camera, a display, a processor operatively coupled with the camera and the display, and a memory operatively coupled with the processor, wherein the memory may store instructions, when executed, causing the processor to store information of a purchased item in relation to the electronic device, in the memory, after storing the item information, display an image acquired using the camera, as a preview image on the display, identify that at least one object in the image corresponds to the item, based on identifying that the at least one object in the image corresponds to the item, obtain information of at least one visual object, and display the at least one visual object superimposed on the image associating the at least one object with the at least one visual object, on the display.

### CROSS-REFERENCE TO RELATED APPLICATION(S)

This application is based on and claims priority under 35 U.S.C. § 119 to Korean Patent Application No. 10-2019-0003427, filed on Jan. 10, 2019, in the Korean Intellectual Property Office, the disclosure of which is incorporated by reference herein in its entirety.

### TECHNICAL FIELD

Certain embodiments of the disclosure relate generally to an electronic device and a method for displaying at least one visual object.

### BACKGROUND

As electronic device technology advances, an electronic device may provide various experiences to a user. For example, the electronic device may recognize a real object through a camera, and display the recognized object on a preview.

However, the displayed object may have not have relevance to the user. Accordingly, it is important to display recognized objects that are relevant to the user.

### SUMMARY

An electronic device comprising: a camera; a communication circuit; a display; a processor operatively coupled with the camera, the communication circuit, and the display; and a memory operatively coupled with the processor, wherein the memory stores instructions, when executed, causing the processor to, transmit information of an item purchased with the electronic device, to a server using the communication circuit, after transmitting the item information, display an image acquired using the camera, on the display, transmit at least a portion of the image to the server using the communication circuit, and superimpose at least one visual object received from the server on the image to associate the at least one object with the at least one visual object, on the display when the server identifies at least one object in the image corresponds to the purchased item.

According to certain embodiments, a method comprises transmitting information of an item purchased using the electronic device, to a server; after transmitting the item information, displaying an image acquired using a camera of the electronic device, on a display of the electronic device; transmitting at least part of the image to the server; and superimposing at least one visual object received from the server on the image to associate the at least one object with the at least one visual object, on a display of the electronic device.

An electronic device according to certain embodiments may include a camera, a display, a processor operatively coupled with the camera and the display, and a memory operatively coupled with the processor, wherein the memory may store instructions, when executed, causing the processor to store information of a purchased item in relation to the electronic device, in the memory, after storing the item information, display an image acquired using the camera, as a preview image on the display, identify that at least one object in the image corresponds to the item, based on identifying that the at least one object in the image corresponds to the item, obtain information of at least one visual object, and display the at least one visual object superimposed on the image associating the at least one object with the at least one visual object, on the display.

Other aspects, advantages, and salient features of the disclosure will become apparent to those skilled in the art from the following detailed description, which, taken in conjunction with the annexed drawings, discloses certain embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an integrated intelligence system according to an embodiment;

FIG. 2 illustrates screens for processing a received voice input through an intelligent application in a user terminal according to certain embodiments;

FIG. 3 illustrates a block diagram of an electronic device in a network environment according to certain embodiments;

FIG. 4 illustrates a structure of a system including an electronic device for providing at least one visual object and a server according to certain embodiments;

FIG. 5 illustrates an example of operations of an electronic device according to certain embodiments;

FIG. 6 illustrates another example of operations of an electronic device according to certain embodiments;

FIG. 7A illustrates an example of a user interface of an electronic device according to certain embodiments;

FIG. 7B illustrates another example of the user interface of the electronic device according to certain embodiments;

FIG. 8A illustrates an example of classifying at least one keyword in a server according to certain embodiments;

FIG. 8B illustrates another example of classifying at least one keyword in the server according to certain embodiments;

FIG. 9 illustrates an example of a plurality of categories of a context provider according to certain embodiments;

FIG. 10A and FIG. 10B illustrate an example of generating at least one visual object in an electronic device according to certain embodiments;

FIGS. 11A, 11B, and 11C illustrate another example of displaying a visual object in an electronic device according to certain embodiments; and

FIG. 12 illustrates yet another example of a user interface of an electronic device according to certain embodiments.

Throughout the drawings, like reference numerals will be understood to refer to like parts, components and structures.

### DETAILED DESCRIPTION

When displaying a recognized object seen by a camera on the preview display, the electronic device might not display an object based on a user's purchase history. Accordingly, according to certain aspects of the present disclosure, objects are displayed from the camera view based on the user's purchase history or user experience of the electronic device.

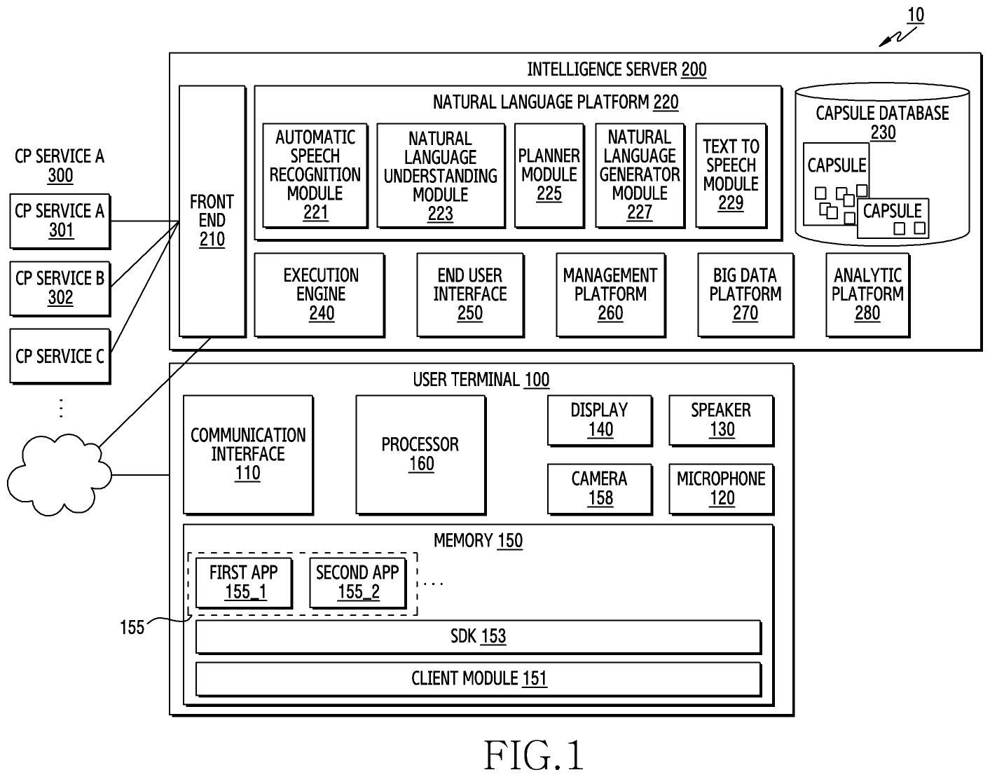

FIG. 1 illustrates a block diagram of an integrated intelligence system according to an embodiment.

Referring to FIG. 1, the integrated intelligence system 10 of an embodiment may include a user terminal 100, an intelligent server 200, and a service server 300.

In certain embodiments, the user terminal 100 can be used for purchasing or shopping for an item. In a later image captured by a camera at the user terminal 100, if the item appear, a visual object can be superimposed on the image. The intelligent server 200 stores the items, receives the images, determines if the items are in the images, and when the items are in the images, creates and sends a visual object to the user terminal. In some embodiments, the service server 300 can facilitate purchasing of the item by the user terminal.

The user terminal 100 of an embodiment may be a terminal device (or an electronic device) for connecting to Internet, and may be, for example, a mobile phone, a smartphone, a personal digital assistant (PDA), a notebook computer, a television (TV), white goods, a wearable device, a head mounted device (HMD), or a smart speaker.

According to an embodiment, the user terminal 100 may include a communication interface 110, a microphone 120, a speaker 130, a display 140, a memory 150, camera 158, or a processor 160. Such components may be operatively or electrically coupled with each other.

The communication interface 110 of an embodiment may be configured to transmit and receive data by connecting to an external device. The microphone 120 of an embodiment may receive and convert a sound (e.g., a user utterance) to an electric signal. The speaker 130 of an embodiment may output the electric signal as a sound (e.g., voice). The display 140 of an embodiment may be configured to display an image or a video. The display 140 of an embodiment may display a graphic user interface (GUI) of an app (or an application program) which is executed.

The memory 150 of an embodiment may store a client module 151, a software development kit (SDK) 153, and a plurality of apps 155. The client module 151 and the SDK 153 may configure a framework (or a solution program) for executing general-purpose functionality. In addition, the client module 151 and the SDK 153 may configure a framework for processing a voice input.

The memory 150 of an embodiment may be a program for performing designated functions of the apps 155. According to an embodiment, the apps 155 may include a first app 155_1 and a second app 155_3 According to an embodiment, the apps 155 may include a plurality of actions for executing the designated functions respectively. For example, the apps 155 may include an alarm app, a message app, and/or a schedule app. According to an embodiment, the apps 155 may be executed by the processor 160 to sequentially execute at least part of the actions.

The camera 158 according to an embodiment is configured to take a photograph or image of the scene surrounding the user terminal 100.

The processor 160 of an embodiment may control actions of the user terminal 100. For example, the processor 160 may be electrically coupled with the communication interface 110, the microphone 120, the speaker 130, and the display 140.

The processor 160 of an embodiment may perform a designated function by executing a program stored in the memory 150. For example, the processor 160 may execute at least one of the client module 151 or the SDK 153, and thus perform the following actions to process the voice input. The processor 160 may, for example, control actions of the apps 155 through the SDK 153. The following actions described as the actions of the client module 151 or the SDK 153 may be carried out by the processor 160.

The client module 151 of an embodiment may receive a voice input. For example, the client module 151 may receive a voice signal corresponding to a user utterance detected through the microphone 120. The client module 151 may transmit the received voice input to the intelligent server 200. The client module 151 may transmit status information of the user terminal 100 to the intelligent server 200, together with the received voice input. The status information may be, for example, execution state information of the app.

The client module 151 of an embodiment may receive a result corresponding to the received voice input. For example, if the intelligent server 200 may calculate the result corresponding to the received voice input, the client module 151 may receive the result corresponding to the received voice input. The client module 151 may display the received result on the display 140.

The client module 151 of an embodiment may receive a plan corresponding to the received voice input. The client module 151 may display a result of executing the actions of the app according to the plan, on the display 140. The client module 151 may, for example, sequentially display the execution results of the actions. The user terminal 100 may display, for example, only some (e.g., the last action result) of the execution results of the actions on the display 140.

According to an embodiment, the client module 151 may receive a request for obtaining necessary information to calculate the result corresponding to the voice input, from the intelligent server 200. According to an embodiment, the client module 151 may transmit the necessary information to the intelligent server 200, in response to the request.

The client module 151 of an embodiment may transmit the execution result information of the actions based on the plan, to the intelligent server 200. The intelligent server 200 may identify that the received voice input is processed correctly, using the result information.

The client module 151 of an embodiment may include a speech recognition module. According to an embodiment, the client module 151 may recognize a voice input for executing a limited function, through the speech recognition module. For example, the client module 151 may execute an intelligent app for processing a voice input to perform an organized action through a designated input (e.g., Wake up!).

The intelligent server 200 of an embodiment may receive information relating to a user voice input from the user terminal 100 over a communication network. According to an embodiment, the intelligent server 200 may change data relating to the received voice input to text data. According to an embodiment, based on the text data, the intelligent server 200 may generate a plan for performing a task corresponding to the user voice input.

According to an embodiment, the plan may be generated by an artificial intelligent (AI) system. The AI system may be a rule-based system or a neural network-based system (e.g., a feedforward neural network (FNN) or a recurrent neural network (RNN)). Alternatively, the AI system may be a combination of them, or other AI system. According to an embodiment, the plan may be selected from a set of predefined plans, or may be generated in real time in response to a user request. For example, the AI system may select at least one plan from a plurality of predefined plans.

The intelligent server 200 of an embodiment may transmit the result according to the generated plan, to the user terminal 100, or may transmit the generated plan to the user terminal 100. According to an embodiment, the user terminal 100 may display the result according to the plan, on the display 140. According to an embodiment, the user terminal 100 may display the result of the action execution according to the plan, on the display 140.

The intelligent server 200 of an embodiment may include a front end 210, a natural language platform 220, a capsule database (DB) 230, an execution engine 240, an end user interface 250, a management platform 260, a big data platform 270, or an analytic platform 280.

The front end 210 of an embodiment may receive the received voice input from the user terminal 110. The front end 210 may transmit a response corresponding to the voice input.

According to an embodiment, the natural language platform 220 may include an automatic speech recognition (ASR) module 221, a natural language understanding (NLU) module 223, a planner module 225, a natural language generator (NLG) module 227, or a text to speech (TTS) module 229.

The ASR module 221 of an embodiment may convert the voice input received from the user terminal 100 to the text data. The NLU module 223 of an embodiment may obtain user's intent using the text data of the voice input. For example, the NLU module 223 may obtain the user's intent through syntactic analysis or semantic analysis. The NLU module 223 of an embodiment may obtain a meaning of a word extracted from the voice input using linguistic characteristics (e.g., grammatical elements) of a morpheme or a phrase, and determine the user's intent by matching the obtained meaning of the word to the intent.

The planner module 225 of an embodiment may generate the plan using the intent determined at the NLU module 223 and a parameter. According to an embodiment, the planner module 225 may determine a plurality of domains for executing a task, based on the determined intent. The planner module 225 may determine a plurality of actions of the domains determined based on the intent. According to an embodiment, the planner module 225 may determine a parameter required to perform the determined actions, or determine a result value outputted by executing the actions. The parameter and the result value may be defined as a concept of a designated type (or class). Hence, the plan may include a plurality of actions determined by the user's intent, and a plurality of concepts. The planner module 225 may determine relationships between the actions and between the concepts, by stages (or hierarchically). For example, the planner module 225 may determine an execution order of the actions determined based on the user's intent, based on the concepts. In other words, the planner module 225 may determine the execution order of the actions, based on the parameter for executing the actions and the result outputted by executing the actions. Hence, the planner module 225 may generate the plan including association information (e.g., ontology) between the actions, and between the concepts. The planner module 225 may generate the plan using information stored in the capsule DB 230 which stores a set of relationships of the concepts and the actions.

The NLU module 227 of an embodiment may change designated information into text. The information changed into the text may be in the form of natural language speech. The TTS module 229 of an embodiment may change the text information to voice information.

According to an embodiment, some or whole of the functions of the natural language platform 220 may be implemented at the user terminal 100.

The capsule DB 230 may store relationship information of the concepts and the actions corresponding to the domains. The capsule according to an embodiment may include a plurality of action objects or action information and concept objects or concept information in the plan. According to an embodiment, the capsule DB 230 may store a plurality of capsules in the form of a concept action network (CAN). According to an embodiment, the capsules may be stored in a function registry of the capsule DB 230.

The capsule DB 230 may include a strategy registry which stores strategy information for determining the plan corresponding to the voice input. If a plurality of plans corresponds to the voice input, the strategy information may include reference information for determining one plan. According to an embodiment, the capsule DB 230 may include a follow up registry which stores follow up action information to suggest a follow up action to the user under a designated situation. The follow up action may include, for example, a follow up utterance. According to an embodiment, the capsule DB 230 may include a layout registry which stores layout information of the information outputted at the user terminal 100. According to an embodiment, the capsule DB 230 may include a vocabulary registry which stores vocabulary information of the capsule information. According to an embodiment, the capsule DB 230 may include a dialog registry which stores dialog (or interaction) information of the user. The capsule DB 230 may update the stored object through a developer tool. The developer tool may include, for example, a function editor for updating the action object or the concept object. The developer tool may include a vocabulary editor for updating the vocabulary. The developer tool may include a strategy editor for generating and registering a strategy to determine the plan. The developer tool may include a dialog editor for creating a dialog with the user. The developer tool may include a follow up editor for activating a follow up goal and editing the follow up utterance to provide a hint. The follow up goal may be determined based on a current goal, user's preference, or environmental condition. In certain embodiments, the capsule DB 230 may be implemented in the user terminal 100.

The execution engine 240 of an embodiment may calculate a result using the generated plan. The end user interface 250 may transmit the calculated result to the user terminal 100. Hence, the user terminal 100 may receive the result, and provide the received result to the user. The management platform 260 of an embodiment may manage information used by the intelligent server 200. The big data platform 270 of an embodiment may collect user's data. The analytic platform 280 of an embodiment may manage quality of service (QoS) of the intelligent server 200. For example, the analytic platform 280 may manage components and a processing rate (or efficiency) of the intelligent server 200.

The service server 300 of an embodiment may provide a designated service (e.g., food ordering or hotel booking) to the user terminal 100. According to an embodiment, the service server 300 may be a server operated by a third party. The service server 300 of an embodiment may provide the intelligent server 200 with information for generating the plan corresponding to the received voice input. The provided information may be stored in the capsule DB 230. In addition, the intelligent server 200 may provide result information based on the plan to the intelligent server 200.

In the integrated intelligence system 10 as describe above, the user terminal 100 may provide various intelligent services to the user in response to a user input. The user input may include, for example, an input via a physical button, a touch input, or a voice input.

In an embodiment, the user terminal 100 may provide a speech recognition service through an intelligent app (or a speed recognition app) stored therein. In this case, for example, the user terminal 100 may recognize a user utterance or voice input received via the microphone, and provide the user with a service corresponding to the recognized voice input.

In an embodiment, based on the received voice input, the user terminal 100 may perform a designated action alone or with the intelligent server 200 and/or a service server. For example, the user terminal 100 may execute an app corresponding to the received voice input, and perform the designated action using the executed app.

In an embodiment, if the user terminal 100 provides the service together with the intelligent server 200 and/or the service server, the user terminal 100 may detect a user utterance using the microphone 120 and generate a signal (or voice data) corresponding to the detected user utterance. The user terminal 100 may transmit the voice data to the intelligent server 200 using the communication interface 110.

The intelligent server 200 according to an embodiment may generate a plan for executing a task corresponding to the voice input, or a result of the action according to the plan, in response to the voice input received from the user terminal 100. The plan may include, for example, a plurality of actions for executing the task corresponding to the user's voice input, and a plurality of concepts relating to the actions. The concept may define a parameter inputted to the execution of the actions, or a result value outputted by the execution of the actions. The plan may include association information between the actions, and between the concepts.

The user terminal 100 of an embodiment may receive the response using the communication interface 110. The user terminal 100 may output the voice signal generated in the user terminal 100 to outside using the speaker 130, or output an image generated in the user terminal 100 to outside using the display 140.

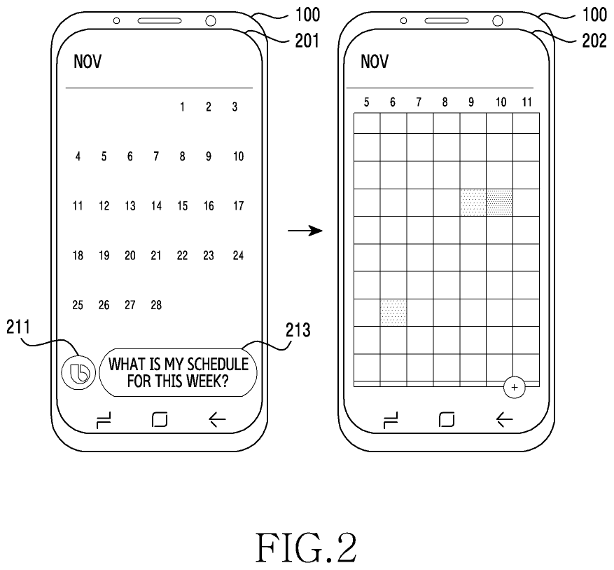

FIG. 2 illustrates screens for processing a received voice input through an intelligent application in a user terminal according to certain embodiments.

The user terminal 100 may execute an intelligent app to process a user input through the intelligent server 200.

According to an embodiment, in a screen 201, if recognizing a designated voice input (e.g., Wake up!) or receiving an input through a hardware key (e.g., a dedicated hardware key), the user terminal 100 may execute the intelligent app to process the voice input. The user terminal 100 may execute, for example, the intelligent app while running a schedule app. According to an embodiment, the user terminal 100 may display an object (e.g., an icon) 211 corresponding to the intelligent app on the display 140. According to an embodiment, the user terminal 100 may receive the voice input according to a user utterance. For example, the user terminal 100 may receive a voice input “What is my schedule for this week?”. According to an embodiment, the user terminal 100 may display a user interface (UI) 213 (e.g., an input window) of the intelligent app displaying text data of the received voice input, on the display 140.

According to an embodiment, in a screen 202, the user terminal 100 may display results corresponding to the received voice input on the display 140. For example, the user terminal 100 may receive a plan corresponding to the received user input, and display only “schedules for this week” according to the plan on the display 140.

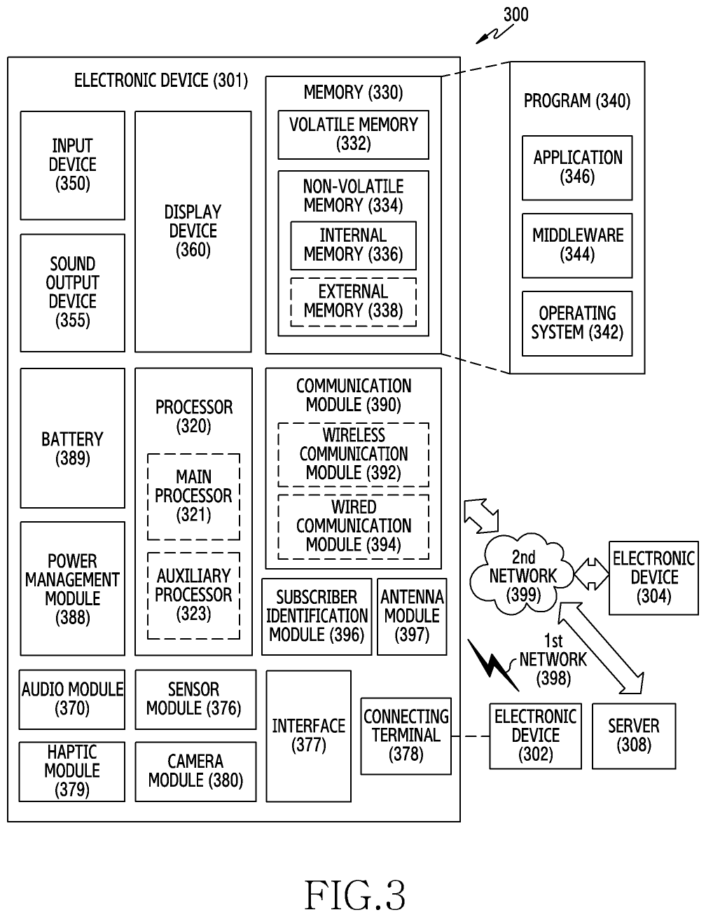

FIG. 3 is a block diagram illustrating an electronic device 301 in a network environment 300 according to certain embodiments.

Referring to FIG. 3, the electronic device 301 in the network environment 300 may communicate with an electronic device 302 via a first network 398 (e.g., a short-range wireless communication network), or an electronic device 304 or a server 308 via a second network 399 (e.g., a long-range wireless communication network). According to an embodiment, the electronic device 301 may communicate with the electronic device 304 via the server 308. According to an embodiment, the electronic device 301 may include a processor 320, memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) 396, or an antenna module 397. In some embodiments, at least one (e.g., the display device 360 or the camera module 380) of the components may be omitted from the electronic device 301, or one or more other components may be added in the electronic device 301. In some embodiments, some of the components may be implemented as single integrated circuitry. For example, the sensor module 376 (e.g., a fingerprint sensor, an iris sensor, or an illuminance sensor) may be implemented as embedded in the display device 360 (e.g., a display).

The processor 320 may execute, for example, software (e.g., a program 340) to control at least one other component (e.g., a hardware or software component) of the electronic device 301 coupled with the processor 320, and may perform various data processing or computation. According to one embodiment, as at least part of the data processing or computation, the processor 320 may load a command or data received from another component (e.g., the sensor module 376 or the communication module 390) in volatile memory 332, process the command or the data stored in the volatile memory 332, and store resulting data in non-volatile memory 334. According to an embodiment, the processor 320 may include a main processor 321 (e.g., a central processing unit (CPU) or an application processor (AP)), and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321, or to be specific to a specified function. The auxiliary processor 323 may be implemented as separate from, or as part of the main processor 321.

The auxiliary processor 323 may control at least some of functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to an embodiment, the auxiliary processor 323 (e.g., an image signal processor or a communication processor) may be implemented as part of another component (e.g., the camera module 380 or the communication module 390) functionally related to the auxiliary processor 323.

The memory 330 may store various data used by at least one component (e.g., the processor 320 or the sensor module 376) of the electronic device 301. The various data may include, for example, software (e.g., the program 340) and input data or output data for a command related thererto. The memory 330 may include the volatile memory 332 or the non-volatile memory 334.

The program 340 may be stored in the memory 330 as software, and may include, for example, an operating system (OS) 342, middleware 344, or an application 346.

The input device 350 may receive a command or data to be used by other component (e.g., the processor 320) of the electronic device 301, from the outside (e.g., a user) of the electronic device 301. The input device 350 may include, for example, a microphone, a mouse, a keyboard, or a digital pen (e.g., a stylus pen).

The sound output device 355 may output sound signals to the outside of the electronic device 301. The sound output device 355 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 360 may visually provide information to the outside (e.g., a user) of the electronic device 301. The display device 360 may include, for example, a display, a hologram device, or a projector and control circuitry to control a corresponding one of the display, hologram device, and projector. According to an embodiment, the display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. According to an embodiment, the audio module 370 may obtain the sound via the input device 350, or output the sound via the sound output device 355 or a headphone of an external electronic device (e.g., an electronic device 302) directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. According to an embodiment, the sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device (e.g., the electronic device 302) directly (e.g., wiredly) or wirelessly. According to an embodiment, the interface 377 may include, for example, a high definition multimedia interface (HDMI), a universal serial bus (USB) interface, a secure digital (SD) card interface, or an audio interface.

A connecting terminal 378 may include a connector via which the electronic device 301 may be physically connected with the external electronic device (e.g., the electronic device 302). According to an embodiment, the connecting terminal 378 may include, for example, a HDMI connector, a USB connector, a SD card connector, or an audio connector (e.g., a headphone connector).

The haptic module 379 may convert an electrical signal into a mechanical stimulus (e.g., a vibration or a movement) or electrical stimulus which may be recognized by a user via his tactile sensation or kinesthetic sensation. According to an embodiment, the haptic module 379 may include, for example, a motor, a piezoelectric element, or an electric stimulator.

The camera module 380 may capture a still image or moving images. According to an embodiment, the camera module 380 may include one or more lenses, image sensors, image signal processors, or flashes.

The power management module 388 may manage power supplied to the electronic device 301. According to one embodiment, the power management module 388 may be implemented as at least part of, for example, a power management integrated circuit (PMIC).

The battery 389 may supply power to at least one component of the electronic device 301. According to an embodiment, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the application processor (AP)) and supports a direct (e.g., wired) communication or a wireless communication. According to an embodiment, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as Bluetooth™, wireless-fidelity (Wi-Fi) direct, or infrared data association (IrDA)) or the second network 399 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The antenna module 397 may transmit or receive a signal or power to or from the outside (e.g., the external electronic device) of the electronic device 301. According to an embodiment, the antenna module 397 may include an antenna including a radiating element composed of a conductive material or a conductive pattern formed in or on a substrate (e.g., PCB). According to an embodiment, the antenna module 397 may include a plurality of antennas. In such a case, at least one antenna appropriate for a communication scheme used in the communication network, such as the first network 398 or the second network 399, may be selected, for example, by the communication module 390 (e.g., the wireless communication module 392) from the plurality of antennas. The signal or the power may then be transmitted or received between the communication module 390 and the external electronic device via the selected at least one antenna. According to an embodiment, another component (e.g., a radio frequency integrated circuit (RFIC)) other than the radiating element may be additionally formed as part of the antenna module 397.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 301 and the external electronic device 304 via the server 308 coupled with the second network 399. Each of the electronic devices 302 and 304 may be a device of a same type as, or a different type, from the electronic device 301. According to an embodiment, all or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 340) including one or more instructions that are stored in a storage medium (e.g., internal memory 336 or external memory 338) that is readable by a machine (e.g., the electronic device 301). For example, a processor (e.g., the processor 320) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

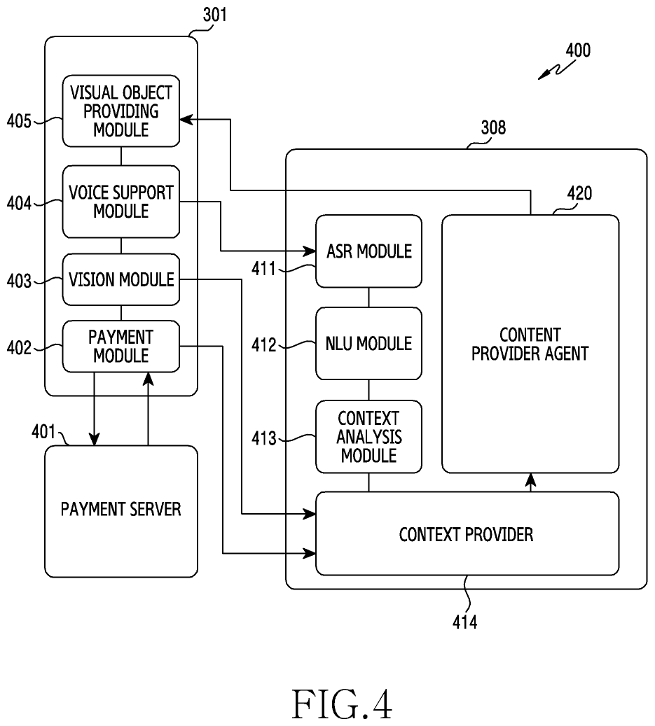

FIG. 4 illustrates a structure of a system 400 including an electronic device 301 for providing at least one visual object and a server 208 according to certain embodiments.

In certain embodiments, the electronic device 301 may include a payment module 402, a vision module 403, a voice support module 404 or a visual object providing module 405. Although not depicted, a processor 320 may control operations of the electronic device 301. To control the operations of the electronic device 301, the processor 320 may be operatively coupled with other component of the electronic device 301, such as the payment module 402, the vision module 403, the voice support module 404 or the visual object providing module 405.

According to an embodiment, the payment module 402 of the electronic device 301 may perform payment. The payment module 402 may transmit a payment request signal to a payment server 401. The payment server 401 may receive the payment request signal from the payment module 402. According to an embodiment, the payment request signal may include payment card information (e.g., a card number, a valid date, a password). The card information may be encrypted and transmitted to the payment server 401. The payment server 401 may transmit payment approval information to the payment module 402. The payment module 402 may receive the payment approval information from the payment server 401. According to an embodiment, the payment server 401 may correspond to a card company server or a bank server. According to an embodiment, the payment module 402 may transmit to a server 308 (e.g., a context provider 414) user's card information (e.g., credit card information, membership information, bank account information) or purchase information (e.g., price, goods) of the electronic device 301.

According to an embodiment, the vision module 403 of the electronic device 301 may obtain display sequence information, display position information or vision information for providing a visual object. According to an embodiment, the display sequence information may be determined according to a user's purchase history or purchase time. For example, if the user has a plurality of purchase histories for a particular brand product, the vision module 403 may first display a visual object indicating the particular brand. For example, the vision module 403 may determine a priority of the position for displaying the visual object based on time. In certain embodiments, the vision module 403 may maintain statistics for each brand purchased, type of product purchased, time of day, day of week, etc.

According to an embodiment, the vision module 403 may analyze an image (e.g., a preview image) acquired through the camera module 380. The vision module 403 may obtain vision information of the acquired image. The vision information may include information of at least one object in the image. For example, the vision information may include a symbol, a mark, a brand, a text, logo, or attribution of at least one object in the image.

According to an embodiment, the vision module 403 may determine a display position of the at least one visual object, based on at least one object in the image acquired through the camera module 380. The vision module 403 may obtain vision information at the determined display position. According to an embodiment, the vision module 403 may identify whether there is the display position information or the vision information. According to an embodiment, if the display position or vision information exists, the vision module 403 may transmit the display position information or the vision information to the server 308 (e.g., the context provider 414). According to an embodiment, if the display position or vision information does not exist, the vision module 403 may transmit information indicating no display position information or vision information identified, to the server 308 (e.g., the context provider 414).

According to an embodiment, the voice support module 404 may receive the voice signal including the user's utterance through the input device 350 (e.g., a microphone). According to an embodiment, the voice support module 404 may transmit the received voice signal to the server 308. According to an embodiment, if the electronic device 301 includes a module for the voice recognition, the voice support module 404 may not transmit the voice signal to the server 308. According to an embodiment, the electronic device 301 may include at least one of an ASR module 411, an NLU module 412, or a context analysis module 413 of the server 308. The electronic device 301 may analyze the user's voice signal of the electronic device 301. Based on the user's voice signal, the electronic device 301 may acquire and store information from the user's voice signal.

According to an embodiment, the voice support module 404 may interwork with a plurality of applications in the electronic device 301. For example, the voice support module 404 may receive a user's utterance for ordering a coffee. The voice support module 404 may execute an application for the coffee order and transmit coffer order information to the application for the coffee order. For example, the voice support module 404 may receive a user's utterance for payment. The voice support module 404 may execute a payment application and transmit payment information to the payment application.

According to an embodiment, the visual object providing module 405 may determine a display position or a display sequence of at least one visual object. For example, the visual object providing module 405 may request at least one visual object from the server 308, based on acquiring an image using the camera module 380 of the electronic device 301. The visual object providing module 405 may receive information of the at least one visual object from the server 308. The visual object providing module 405 may receive display sequence information or display position information from the vision module 403. Based on the received display sequence information or display position information, the visual object providing module 405 may finally determine the display sequence or the display position of at least one visual object.

For example, the visual object providing module 405 may obtain information of the at least one visual object, using data stored in the memory 330. For example, the visual object providing module 405 may obtain the information of the at least one visual object, using the data stored in the memory 330, without using the server 308. The visual object providing module 405 may determine the display sequence or the display position of at least one visual object, based on the obtained at least one visual object information and the display sequence information or the display position information obtained from the vision module 403.

For example, the visual object providing module 405 may obtain information of the at least one visual object, while purchasing goods (or paying) using the electronic device 301. For example, the visual object providing module 405 may receive the at least one visual object information from the server 308, or obtain the at least one visual object information using the data stored in the memory 330. For example, in certain embodiments, the visual object providing module 405 may examine web pages immediately preceding a “checkout page.” The visual object providing module 405 may determine the display sequence or the display position of at least one visual object, based on the obtained at least one visual object information and the display sequence information or the display position information obtained from the vision module 403.

For example, the visual object providing module 405 may obtain the at least one visual object information in real time, based at least on the vision information. The visual object providing module 405 may determine the display sequence or the display position of at least one visual object, based on, but not limited to, the obtained at least one visual object information and the display sequence information or the display position information obtained from the vision module 403.

In certain embodiments, the server 308 may include the ASR module 411, the NLU module 412, a context analysis module 413, the context provider 414, or a content provider agent 420.

According to an embodiment, the ASR module 411 may receive and convert a voice input including a user's utterance to text data. According to an embodiment, the ASR module 411 may receive the voice signal including the user's utterance from the voice support module 404 of the electronic device 301. The ASR module 411 may convert the user's utterance of the received voice signal to the text. For example, if receiving a voice signal including a user's utterance “Please order iced café latte large size from OO coffee shop” from the voice support module 404 of the electronic device 301, the ASR module 411 may convert the user's utterance into the text. According to an embodiment, the ASR module 411 may transmit the user's utterance converted into the text, to the NLU module 412.

According to an embodiment, the NLU module 412 may obtain a meaning of a word extracted from the user utterance using linguistic characteristic (e.g., grammatical elements) of a morpheme or a phrase. According to an embodiment, the NLU module 412 may receive the user's utterance converted into the text, from the ASR module 411. The NLU module 412 may receive the user's utterance changed into the text and extract at least one keyword. For example, if the user's utterance changed into the text is “Please order iced café latte large size from OO coffee shop”, the NLU module 412 may extract “OO coffee shop”, “ice café latte”, or “large size”. According to an embodiment, the NLU module 412 may transmit the at least one keyword to the context analysis module 413.

According to an embodiment, the context analysis module 413 may identify a user's intent by analyzing context between the at least one keyword received from the NLU module 412. For example, based on receiving the keyword “OO coffee shop”, “ice café latte”, or “large size” from the NLU module 412, the context analysis module 413 may identify the user's coffer order. According to an embodiment, the context analysis module 413 may transmit information of the at least one keyword or the user's intent of the user's utterance, to the context provider 414.

According to an embodiment, the context provider 414 may classify and store the at least one keyword of the user's utterance. For example, the context provider 414 may request category information from the content provider agent 420. For example, in response to the request from the context provider 414, the content provider agent 420 may provide the context provider 414 with the category information which is obtained based on data (e.g., data stored in the electronic device 301 if an application used to purchase or inquire of a product is installed or data stored in the electronic device 301 if an application relating to a content provider server is installed) stored in the electronic device 301. The context provider 414 may receive the category information from the content provider agent 420.

For example, in response to the request from the context provider 414, the content provider agent 420 may request the category information from the content provider server (e.g., an open market server or a coffee shop server) and receive the category information from the content provider server in response to the request. The content provider agent 420 may provide the category information to the context provider 414. The context provider 414 may receive the category information from the content provider agent 420. The context provider 414 may classify and store at least one keyword received from the context analysis module 413, based on the received category information.

For example, if receiving from the user a voice signal including an utterance regarding item order in the electronic device 101, the context provider 414 may classify and store item order information in various categories such as a circumstance information category, a shop category, an order category, a profile category, and a payment category. For example, the context provider 414 may store weather, order time, or visit time information in the circumstance information category. For example, the context provider 414 may store location or brand information of a shop for the user's order, in the shop category. For example, the context provider 414 may store user's ordered menu, recipe, and order size information in the order category. For example, the context provider 414 may store user's personal information or goods purchase history in the profile category. For example, the context provider 414 may store payment means, card information, or payment method information in the payment category.

According to an embodiment, the context provider 414 includes, but not limited to, the circumstance information category, the shop category, the order category, the profile category, or the payment category. The context provider 414 may classify and store user information in various categories.

In certain embodiments, the context provider 414 may examine a user utterance and identify verbs, nouns, and proper nouns. The context provider 414 can deem verbs as likely to be commands to make a purchase, while the nouns are likely the purchased item. Proper nouns can be detected by comparing the word to known businesses, or trademarks, etc. The proper nouns can be deemed the distributor of the purchased item, or shop or business.

According to an embodiment, the content provider agent 420 may control operations of the server 308. To control the operations of the server 308, the content provider agent 420 may be operatively coupled with other component of the server 308, such as the ASR module 411, the NLU module 412, the context analysis module 413, or the context provider 414.

According to an embodiment, the content provider agent 420 may classify and store the vision information received from the vision module 403 of the electronic device 301, in the category of the context provider 414. For example, the content provider agent 420 may receive DD coffee mark information of a takeout coffee cup, from the vision module 403. The content provider agent 420 may store the DD coffee in the shop category of the context provider 414.

According to an embodiment, the content provider agent 420 may receive user's payment information from the payment module 402 of the electronic device 301 and classify and store the user's payment information in the category of the context provider 414. The content provider agent 420 may classify at least one keyword based on the user's payment information and store it according to the category. For example, the context provider 414 may receive from the payment module 402 information that the user purchases a monitor of a brand A for one million won. The context provider 414 may store the brand A in the brand category, store the monitor in the product category, and store one million won in the price category.

According to an embodiment, the content provider agent 420 may determine a display sequence or a display position of at least one visual object, based on the display sequence information or the vision information received via the vision module 403. The content provider agent 420 may generate at least one visual object based on the at least one keyword classified by the context provider 414, the display sequence or the display position. In certain embodiments, the visual object may be provided based on the determined display sequence. In certain embodiments, the visual object may be changed into other type, based on vision information updated based on the visual object.

According to an embodiment, the content provider agent 420 may transmit the generated at least one visual object to the visual object providing module 405 of the electronic device 301. The content provider agent 420 may transmit at least one other visual object according to the location or the time of the electronic device 301. For example, user's flight reservation information of the electronic device 301 may be stored in the context provider 414. If the electronic device 301 is located at a different place from a boarding gate of the plane, the content provider agent 420 may generate a visual object for guiding to the boarding gate of the plane and transmit the visual object to the visual object providing module 405 of the electronic device 301.

FIG. 4 describes the electronic device 301 and the server 308, but not limited to, separately. The electronic device 301 may include whole or part of the functional configuration of the server 308. If the electronic device 301 includes whole or part of the functional configuration of the server 308, the electronic device 301 may perform whole or part of the operations of the server 308.

An electronic device according to certain embodiments may include a camera (e.g., the camera 380), a communication circuit (e.g., the communication module 390), a display (e.g., the display device 360), a processor (e.g., the processor 320) operatively coupled with the camera, the communication circuit, and the display, and a memory (e.g., the memory 330) operatively coupled with the processor, wherein the memory may store instructions, when executed, causing the processor to transmit information of a purchased item in relation to the electronic device, to a server using the communication circuit, after transmitting the item information, display an image acquired using the camera, on the display, transmit information of the image to the server using the communication circuit, based on identifying at the server that at least one object in the image corresponds to the item, receive at least one visual object information from the server using the communication circuit, and display the at least one visual object superimposed on the image to associate the at least one object with the at least one visual object, on the display.

In certain embodiments, the at least one object may be covered by superimposing the at least one visual object at least in part.

In certain embodiments, the instructions may cause the processor to, while receiving the at least one visual object information, display a visual effect to indicate transmission of the image information and reception of the at least one visual object information, on the image.

In certain embodiments, the instructions may cause the processor to, in response to receiving a voice signal relating to the item order from a user of the electronic device, provide a service for purchasing the item, and based on providing the service, change the display of the at least one visual object, or change the at least one visual object to other visual object. In certain embodiments, the instructions may cause the processor to transmit a voice signal relating to the item order to the server, to identify and store at least one keyword in the server based at least in part on the voice signal relating to the item order. In certain embodiments, the at least one visual object may be generated at the server based at least in part on the at least one keyword, at least one object in the image, or metadata of the image.

In certain embodiments, the instructions may cause the processor to, based at least in part on the at least one object in the image, determine a display position or a display sequence of the at least one visual object.

In certain embodiments, the instructions may cause the processor to change the at least one visual object based at least in part on time, a place of the electronic device or information of other electronic device connected to the electronic device.

As such, an electronic device according to certain embodiments may include a camera (e.g., the camera 380), a display (e.g., the display device 360), a processor (e.g., the processor 32) operatively coupled with the camera and the display, and a memory (e.g., the memory 330) operatively coupled with the processor, wherein the memory may store instructions, when executed, causing the processor to store information of a purchased item in relation to the electronic device, in the memory, after storing the item information, display an image acquired using the camera, as a preview image on the display, identify that at least one object in the image corresponds to the item, based on identifying that the at least one object in the image corresponds to the item, obtain information of at least one visual object, and display the at least one visual object superimposed on the image to associate the at least one object with the at least one visual object, on the display.

In certain embodiments, the purchased item information may include information of at least one keyword related to the purchased item.

In certain embodiments, the at least one object may be covered by the at least one visual object.

In certain embodiments, the instructions may cause the processor to change the at least one visual object based on time or a place.

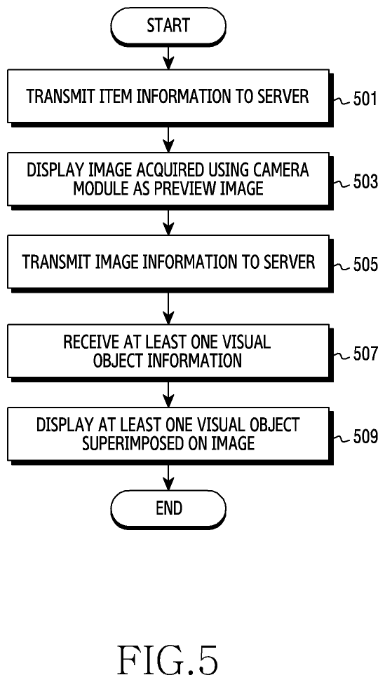

FIG. 5 illustrates an example of operations of an electronic device 301 according to certain embodiments.

Referring to FIG. 5, in operation 501, the processor 320 may transmit information of an item purchased using the electronic device 301, to the server 308. According to an embodiment, the processor 320 may receive a voice signal including a user's utterance from the user. The processor 320 may transmit the voice signal including the user's utterance to the server 308. The server 308 may receive the voice signal including the user's utterance from the electronic device 301. The server 308 may identify at least one keyword in the user's utterance and store it according to the category. For example, the processor 320 may receive the voice signal including the user's utterance “Please order iced americano large size from OO coffee shop” from the user. The processor 320 may transmit the received voice signal to the server 308. The server 308 may store the keyword “OO coffee shop”, “ice americano”, or “large size” of the user's utterance according to the category. For example, the processor 320 may store “OO coffee” in the brand category, store “iced americano” in the menu category, and store “large size” in the order category.

In operation 503, after transmitting the item information to the server 308, the processor 320 may display an image acquired using the camera module 380 (e.g., a camera) of the electronic device 301, as a preview image on the display device 360 (e.g., a display) of the electronic device 301. According to an embodiment, the processor 320 may display the purchased item as the preview image on the display device 360 of the electronic device 301. The processor 320 may identify at least one object indicating the purchased item of the preview image. Based on the at least one object, the processor 320 may obtain image information through the vision module 403. According to an embodiment, the processor 320 may determine a first display sequence or a first display position for displaying at least one visual object based on at least one object in the image. For example, in the image including an object indicating a takeout coffee cup, the processor 320 may obtain information of the object indicating the takeout coffee cup, an object indicating a brand, or an object indicating contents.

For example, an object indicating the brand is usually towards the top of the cup and against a solid colored background. The processor 320 can scan the surface of the cup and detect a sudden changing in pixel values to detect a likely logo. In other embodiments, the processor 320 may have stored coffee cups from common brands, and detect different brands based on the color of the cup. The contents of the coffee cup are likely towards the top of the cup. Generally a dark brown color is likely a cola beverage, while a lighter brown is likely coffee. Lighter colors are usually indicative of ice cream.

Based on the obtained information, the processor 320 may determine the first display sequence or the first display position of the visual object corresponding to the object indicating the takeout coffee cup, a visual object corresponding to the object indicating the brand, or a visual object corresponding to the object indicating the contents. According to an embodiment, the processor 320 may display other visual object (e.g., dots) indicating that at least one object is recognized in the image.

In operation 505, the processor 320 may transmit the image information or at least a portion of the image to the server 308. The server 308 may receive the image information. According to an embodiment, for example, the content provider agent 420 of the server 308 may receive the information of the object indicating the takeout coffee cup, the object indicating the brand, or the object indicating the contents, from the electronic device 301. According to an embodiment, the processor 320 may receive first display sequence or first display position information of the at least one visual object.

In operation 507, the processor 320 may receive the at least one visual object information from the server 308 using the communication module 390 (e.g., a communication circuit), based on identifying that the at least one object of the image corresponds to the item in the server 308. According to an embodiment, the server 308 (e.g., the content provider agent 420) may identify whether at least one object in the received image corresponds to the received item, based on the received image information. According to an embodiment, based on item information stored in the context provider 414 and the received image information, the content provider agent 420 may identify whether at least one object in the received image corresponds to the item.

According to an embodiment, in response to the at least one object corresponding to the item, the content provider agent 420 may generate at least one visual object. According to an embodiment, the content provider agent 420 may generate at least one visual object as one set. The content provider agent 420 may determine a second display sequence or a second display position of at least one visual object.

According to an embodiment, the content provider agent 420 may generate at least one visual object, based the keyword stored in the category of the context provider 414. For example, if “OO coffee” is stored in the brand category, “iced americano” is stored in the menu category, and “large size” is stored in the order category of the context provider 414, the content provider agent 420 may generate a visual object indicating “OO coffee”, a visual object indicating “iced americano”, and a visual object indicating “large size”. For example, if “37° C.”/“99° F.” is stored in the weather category, “coupon reserved 3 times” is stored in a retail shop category, and “5000 won”/“US$4.30” is stored in the payment category of the context provider 414, the content provider agent 420 may generate a visual object indicating “37° C.”/“99° F.”, a visual object indicating “coupon reserved 3 times”, and a visual object indicating “5000 won”/“US$4.30”. According to an embodiment, the content provider agent 420 may change or update the visual object indicating the information stored in the category of the context provider 414, based on a change of context relating to the visual object. For example, the content provider agent 420 may identify that information that the user of the electronic device 301 orders iced americano at 1:00 PM is stored in the context provider 414. The content provider agent 420 may determine that one hour passes after the order, based on the identifications. Based at least on the determination, the content provider agent 420 may generate a visual object indicating ice cubes half melted.

According to an embodiment, the processor 320 may transmit a signal for requesting at least one visual object information, to the server 308 (e.g., the content provider agent 420). The server 308 may receive the signal for requesting the at least one visual object information from the electronic device 301. According to an embodiment, the server 308 may transmit the at least one visual object information to the electronic device 301.

In operation 507, the processor 320 may receive the at least one visual object information from the server 308 through the communication module 390. According to an embodiment, the processor 320 may display another visual object indicating the received the at least one visual object information, ahead of the at least one visual object. In response to receiving the at least one visual object information, the processor 320 may change and display the another visual object with the at least one visual object.

In operation 509, the processor 320 may display at least one visual object superimposed on the image to associate at least one object with at least one visual object, on the display device 360 (e.g., the display). According to an embodiment, at least one object in the image may be superimposed and covered by at least one visual object. The processor 320 may determine a third display sequence or a third display position of at least one visual object. Based on the second display sequence or the second display position determined at the server 308, the processor 320 may determine the third display sequence or the third display position.

According to an embodiment, the first display sequence or the third display position may be determined based on at least one object in the image in the electronic device 301. The second display sequence or the second display position may be determined in the server 308 based on the information stored in the context provider 414 and the first display sequence or the third display position received from the electronic device 301. The third display sequence or the third display position may be determined in the electronic device 301 based on the at least one visual object and the second display sequence or the second display position. The third display sequence may be a final display sequence at the electronic device 301. The third display position may be a final display position at the electronic device 301.

According to an embodiment, based on the third display position, the processor 320 may change and display a size of at least one visual object, according to at least one object in the image. According to an embodiment, the processor 320 may display at least one visual object based on the third display sequence. For example, if at least one visual object is superimposed and displayed, it may be displayed according to the display sequence of at least one object. For example, the processor 320 may display the greatest visual object at the bottom. The processor 320 may display the smallest visual object on the top.

According to an embodiment, the processor 320 may display at least one visual object in various sizes or shapes. The at least one visual object may include visual objects relating to the item or the user. For example, the visual objects may include an object indicating a shape of the ordered item, an object indicating a name of the ordered item, an object indicating a price of the ordered item, and an avatar indicating the user. According to an embodiment, the processor 320 may set a display effect for the at least one visual object. For example, the processor 320 may change transparency of the at least one visual object. For example, the processor 320 may set a motion effect for the at least one visual object.

According to an embodiment, the processor 320 may differently display at least one visual object according to the time or the place of the electronic device 301. For example, if displaying at least one visual object in a plane ticket image, the processor 320 may display remaining time for boarding the plane as at least one visual object. As current time changes, the processor 320 may change and display the remaining time for the plane boarding. For example, based on plane reservation information, the processor 320 may identify that the electronic device 301 is currently at a different location from a boarding gate, before the boarding time. The processor 320 may display a visual object for guiding the user of the electronic device 301 to the boarding gate. The processor 320 may change and display the visual object as the location of the electronic device 301 changes.

As such, the electronic device 301 according to certain embodiments may display at least one visual object as associated with the object corresponding to the item in the image acquired through the camera, thus providing an enhanced user experience. The electronic device 301 according to certain embodiments may provide the enhanced user experience by displaying the at least one visual object and then updating the at least one visual object without re-recognizing the image.

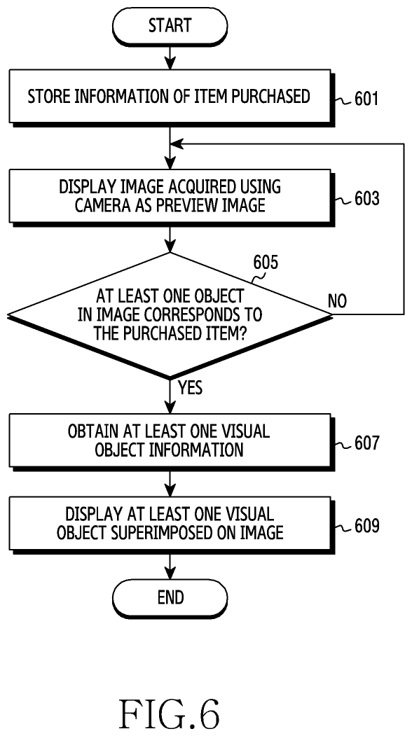

FIG. 6 illustrates another example of operations of an electronic device 301 according to certain embodiments. The electronic device 301 may include at least part of the functional configuration of the server 308. The electronic device 301 may perform the functions of the server 308.

Referring to FIG. 6, in operation 601, the processor 320 of the electronic device 301 may store information of an item purchased using the electronic device 301. According to an embodiment, the processor 320 may receive a voice signal including a user's utterance from the user of the electronic device 301. The processor 320 may extract at least one keyword by analyzing the voice signal including the user's utterance. The processor 320 may store the at least one keyword extracted, in the memory 330 of the electronic device 301. The processor 320 may classify and store the at least one keyword based on a plurality of categories.

In operation 603, the processor 320 may display an image acquired using the camera module 380 (e.g., a camera) of the electronic device 301, as a preview image on the display device 360 (e.g., a display). According to an embodiment, the acquired image may include a shape of the item purchased by the user.

In operation 605, the processor 320 may identify that at least one object in the image corresponds to the purchased item. According to an embodiment, the processor 320 may identify that at least one object in the image corresponds to the purchased item. The processor 320 may identify at least one object in the image by analyzing the image. Based on the stored item information, the processor 320 may identify whether the at least one object corresponds to the purchased item.

In operation 607, the processor 320 may obtain information of at least one visual object. According to an embodiment, the processor 320 may obtain the at least one visual object information related to the purchased item or the user of the electronic device 301. For example, if the user of the electronic device 301 purchases a coffee at a coffee shop, the processor 320 may obtain visual object information indicating the number of coupons reserved at the coffee shop. According to an embodiment, the processor 320 may generate at least one visual object. According to an embodiment, the processor 320 may receive at least one visual object from the server 308. For example, the processor 320 may transmit a signal for requesting at least one visual object information to the server 308. The server 308 may receive the signal for requesting the at least one visual object information from the electronic device 301. The server 308 may transmit the signal including the at least one visual object information to the electronic device 301. The processor 320 may receive the signal including the at least one visual object information from the server 308.

In operation 609, the processor 320 may display at least one visual object superimposed on the image to associate at least one object with at least one visual object. According to an embodiment, the processor 320 may move the at least one visual object according to a user's input of the electronic device 301. According to an embodiment, the processor 320 may change in size or rotate the at least one visual object according to the user's input of the electronic device 301.

As such, the electronic device 301 according to certain embodiments may provide the enhanced user experience by displaying the at least one visual object, as associated with the object in the image corresponding to the item, based on the purchase history of the item. For example, the user may perform actions related to the item through the at least one visual object without switching to other independent application.

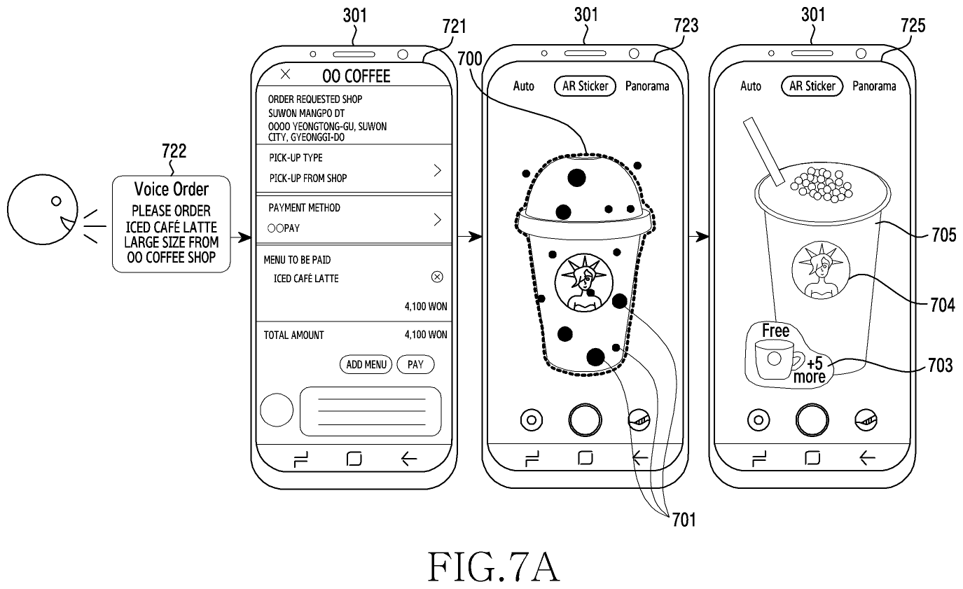

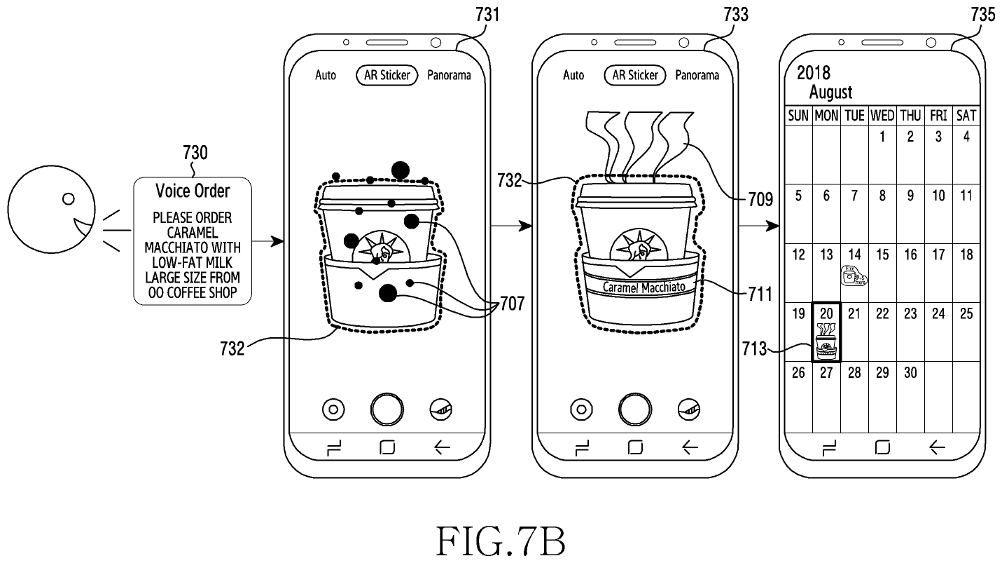

FIG. 7A illustrates an example of a user interface of an electronic device according to certain embodiments.

Referring to FIG. 7A, the processor 320 of the electronic device 301 may receive a voice signal for purchasing an item, from the user. Based on the voice signal 722, the processor 320 may execute an application for purchasing the item. The processor 320 may input user's order information in a user interface 721 of the executed application. For example, the processor 320 may receive a user's utterance 722 of “Please order iced café latte large size from OO coffee shop”. The processor 320 may execute an application for ordering the coffee based on the user's utterance 722. The processor 320 may input order information in the user interface 721 of the application for ordering the coffee. The processor 320 may perform payment based on the inputted order information.

According to an embodiment, the processor 320 may transmit the received voice signal to the server 308. The server 308 may receive the voice signal from the electronic device 301. The content provider agent 420 of the server 308 may change the voice signal including the user utterance into text, and extract and analyze at least one keyword, using the ASR module 411, the NLU module 412 or the context analysis module 713. For example, the processor 320 may receive the voice signal including the user utterance of “Please order iced café latte large size from OO coffee shop”. The processor 320 may transmit the voice signal including the user utterance to the server 308. The content provider agent 420 of the server 308 may analyze the user utterance and classify and store at least one keyword “OO coffee shop” in the shop category, “iced café latte” in the menu category, and “large size” in the order category of the categories of the context provider 414.

According to an embodiment, the processor 320 may transmit item payment information to the server 308. The payment information may include at least one information of a payment method, a payment card type, a coupon use, a price, or a membership card type. The server 308 may receive the item payment information from the electronic device 301. The content provider agent 420 of the server 308 may extract a keyword by analyzing the payment information.

According to an embodiment, the processor 320 may later display an image including the item ordered by the user, as a preview image using the camera module 380. The processor 320 may display the preview image in a user interface 723 of an application. The application may include a camera application or an application operating in an augmented reality (AR) environment. The processor 320 may identify at least one object 700 in the image.

The processor 320 may identify vision information (e.g., brand logo, text or object shape information) of the at least one object 700 in the image. The processor 320 may display a plurality of objects 701 indicating that the at least one object 700 is being identified (or recognized), on the preview image. Based on the at least one object 700, the processor 320 may determine a first display sequence or a first display position of at least one visual object. For example, the processor 320 may identify that at least one object in the image is a takeout coffee cup. The processor 320 may determine the display position to fully superimpose a first visual object 705 on the takeout coffee cup. The processor 320 may determine the display position to superimpose a second visual object 704 on the coffee shop brand logo. The processor 320 may determine the display sequences of the first visual object 705 and the second visual object 704. For example, the processor 320 may determine the display sequences to display the second visual object 704 on the first visual object 705. According to an embodiment, the processor 320 may transmit to the server 308 the vision information of the at least one object of the image, the first display sequence information or the first display position information.

According to an embodiment, the server 308 may receive the vision information of the at least one object of the image, the first display sequence information or the first display position information. The content provider agent 420 of the server 308 may obtain at least one keyword from the vision information of the object. The content provider agent 420 may classify and store the at least one keyword obtained from the vision information of the object, in the category of the context provider 414. For example, the content provider agent 420 may identify coffee shop brand or takeout coffee cup size information from the image including the takeout coffee cup. The content provider agent 420 may identify the keyword “OO coffee” or “large size”. The content provider agent 420 may classify and store “OO coffee” or “large size” in the category of the context provider 414. According to an embodiment, the content provider agent 420 may identify at least one keyword from not only the information acquired from the object of the image but also information in metadata of the image. The information in the metadata of the image may include information of at least one of a current date, a current time, a current weather or a current temperature. For example, the content provider agent 420 may identify the current date “25th May”, the current time “2:15 PM”, or the current temperature “37°”/“99° F.” from the information in the metadata of the image. The content provider agent 420 may store the keywords “25th May”, “2:15 PM”, or “37°”/“99° F.” in the weather/time category of the context provider 414.

According to an embodiment, based on the vision information received from the electronic device 301, the content provider agent 420 may identify that at least one object in the image corresponds to the item ordered by the user of the electronic device 301. For example, the content provider agent 420 may identify that the user of the electronic device 301 orders iced café latte large size from the OO coffee shop. The content provider agent 420 may identify that the object in the image is the coffee ordered by the user of the electronic device 301.

According to an embodiment, the content provider agent 420 may generate at least one visual object based on the at least one keyword in the context provider 414. For example, the content provider agent 420 may generate the first visual object 705 indicating the iced café latte. The content provider agent 420 may generate the second visual object 704 indicating the coffee brand logo. Based on a user's coffee purchase history, the content provider agent 420 may generate a third visual object 703 indicating that a free drink is offered for five more coffees. The content provider agent 420 may identify a second display sequence or a second display position of the first visual object 705, the second visual object 704 and the third visual object 703.

According to an embodiment, the content provider agent 420 may transmit the at least one visual object generated, second display sequence or second display position information to the electronic device 301. The processor 320 of the electronic device 301 may receive the information of the at least one visual object, the second display sequence or the second display position, from the server 308. For example, the processor 320 may receive the information of the first visual object 705, the second visual object 704 and the third visual object 703, from the server 308. The processor 320 may receive the information of the second display sequence or the second display position of the first visual object 705, the second visual object 704 and the third visual object 703, from the server 308.

According to an embodiment, based on the second display sequence or the second display position, the processor 320 may determine a third display sequence or a third display position of the at least one visual object received from the server 308. Based on the third display sequence or the third display position determined, the processor 320 may display the visual object in the user interface of the electronic device 301. For example, the processor 320 may display the first visual object 705 to superimpose on the takeout coffee cup of the image in the user interface 725. The processor 320 may display the second visual object 704 to superimpose on the center of the first visual object 705 in the user interface 725. The processor 320 may display the third visual object 703 to superimpose on a lower left portion of the first visual object 705 in the user interface 725.

As such, based on acquiring the image of the external object using the camera, the electronic device 301 according to certain embodiments may provide the enhanced user experience, by providing the information relating the external object on the preview image displayed to acquire the image.

FIG. 7B illustrates another example of the user interface of the electronic device 301 according to certain embodiments.

Referring to FIG. 7B, the processor 320 of the electronic device 301 may receive a voice signal including a user's utterance 730 of “Please order caramel macchiato with low-fat milk large size from OO coffee shop” from the user. The processor 320 may transmit the received voice signal to the server 308. Next, the processor 320 may display an image including the object corresponding to the coffee takeout cup, as a preview image in a user interface 731 of the electronic device 301. The processor 320 may display other visual objects 707 indicating that an object 732 corresponding to the coffee takeout cup is recognized in the image. According to an embodiment, the processor 320 may recognize the object 732 corresponding to the coffee takeout cup in the image without displaying the other visual objects 707. According to an embodiment, the processor 320 may receive a first visual object 709 and a second visual object 711 from the server 308. The first visual object 709 may indicate hot coffee steam. The second visual object 711 may indicate a tag to the caramel macchiato. The processor 320 may superimpose and display the first visual object 709 and the second visual object 711 on an object 732 corresponding to the coffee takeout cup in a user interface 733

According to an embodiment, the processor 320 may store an image 713 in which the first visual object 709 and the second visual object 711 are superimposed. The processor 320 may display the stored image 713 in a user interface 735 of a calendar application. The processor 320 may display the stored image 713 in a region corresponding to a current date. According to an embodiment, the processor 320 may display an image stored in past, in a region of a corresponding date. According to an embodiment, the processor 320 may display an image relating to the item purchased by the user in a region of a corresponding date. For example, the processor 320 may identify that the user books a plane ticket for a trip to Denmark. The processor 320 may display an image indicating Denmark's flag in a region corresponding to the travel date.

As such, the electronic device 301 according to certain embodiments may provide the enhanced user experience, by displaying the at least one visual object on the preview image displayed while acquiring the image through the camera, and providing the at least one visual object information to other application.

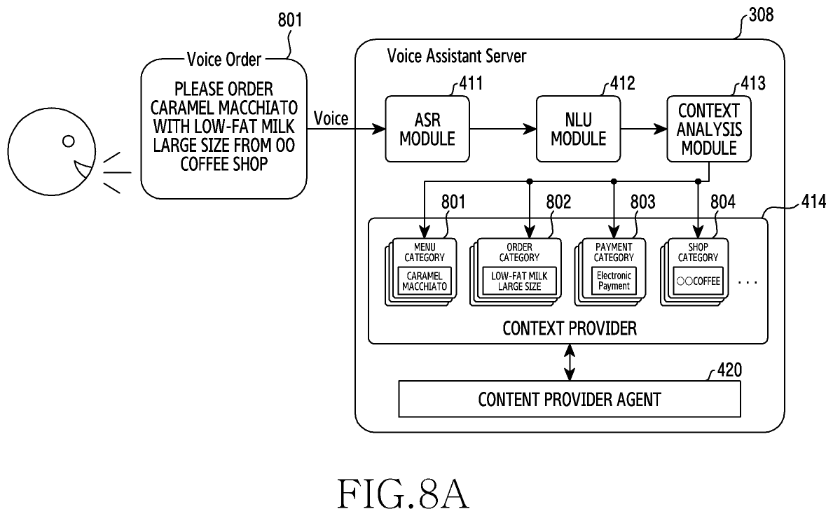

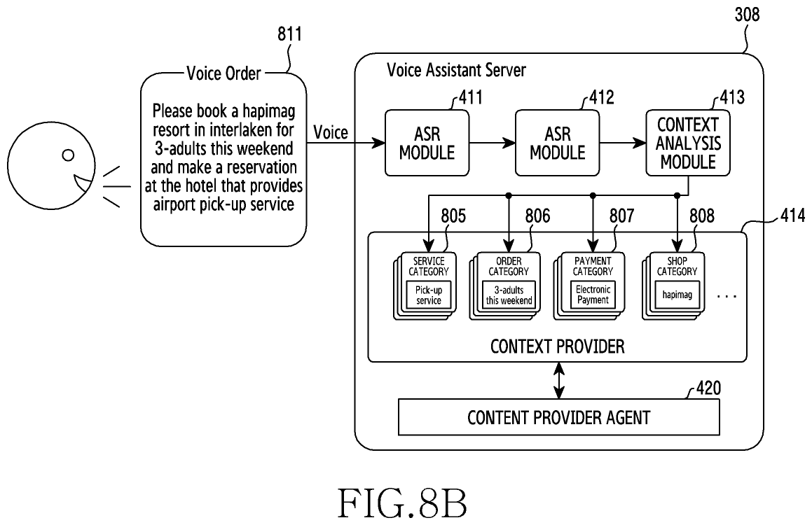

FIG. 8A illustrates an example of classifying at least one keyword in a server 308 according to certain embodiments.

Referring to FIG. 8A, the processor 320 may receive a voice signal including a user's utterance. The processor 320 may transmit the voice signal including the user's utterance to the server 308. For example, the processor 320 may receive a voice signal including a user's utterance 801 of “Please order caramel macchiato with low-fat milk large size from OO coffee shop” from the user. The processor 320 may transmit the received voice signal to the server 308.

According to an embodiment, the content provider agent 420 of the server 308 may convert the voice signal including the user's utterance 801 to text data using the ASR module 411. The content provider agent 420 may transmit the converted text data to the NLU module 412. The content provider agent 420 may obtain a meaning of a word extracted from the voice input using linguistic characteristics (e.g., grammatical elements) of the morpheme or the phrase through the NLU module 412. The content provider agent 420 may extract at least one keyword from the text data using the NLU module 412. For example, if the user's utterance 801 converted to the text data is “Please order caramel macchiato with low-fat milk large size from OO coffee shop”, the content provider agent 420 may extract “OO coffee”, “caramel macchiato”, or “large size” from the user's utterance 801.

According to an embodiment, the content provider agent 420 may transmit the extracted at least one keyword to the context analysis module 413 via the NLU module 412. The content provider agent 420 may identify a user's intent by analyzing context of the at least one keyword in the context analysis module 413. For example, based on the keywords “OO coffee”, “caramel macchiato”, or “large size”, the content provider agent 420 may identify that the user of the electronic device 301 orders coffee.

According to an embodiment, the content provider agent 420 may classify and store at least one keyword of the user's utterance in the category of the context provider 414. For example, the context provider 414 may include a menu category 801, an order category 802, a payment category 803 or a shop category 804. The content provider agent 420 may store “caramel macchiato” in the menu category 802. The content provider agent 420 may store “low-fat milk” and “large size” in the order category 802. The content provider agent 420 may store “OO coffee” in the shop category 804. If receiving a user's voice signal for the payment method or payment method information (e.g., electronic payment) from the payment module 402 of the electronic device 301, the content provider agent 420 may store the payment method information in the payment category 803. For other utterances, the proper noun can be stored in the utterance can be stored in shop category 804, and the noun can be stored in the order category 802.

As such, the electronic device 301 according to certain embodiments may obtain preference information for the user's item of the electronic device 301 using the server 803 associated with the electronic device 301, thus providing an appropriate service to the user.

FIG. 8B illustrates another example of classifying at least one keyword in the server 308 according to certain embodiments.

Referring to FIG. 8B, the processor 320 may receive a voice signal including an utterance 811 of “Please book a hapimag resort in Interlaken for 3-adults this weekend and make a reservation at the hotel that provides airport pick-up service”. The processor 320 may transmit the voice signal to the server 308. The content provider agent 420 of the server 308 may extract at least one keyword from the voice signal including the user's utterance 811 using the ASR module 411, the NLU module 412 or the context analysis module 413. The processor 320 may extract “pick-up service”, “3-adults”, “this weekend” or “hapimag” from the user's utterance 811. The content provider agent 420 may classify and store the keywords in the categories of the context provider 414. The context provider 414 may include a service category 805, an order category 806, a payment category 807 or a shop category 808. The content provider agent 420 may store “pick-up service” in the service category 805. The content provider agent 420 may store “3-adults” or “this weekend” in the order category 806. The content provider agent 420 may store “hapimag” in the shop category 808.

As such, the electronic device 301 according to certain embodiments may obtain the preference information for the user's item of the electronic device 301 using the server 803 associated with the electronic device 301, thus providing an appropriate service to the user.

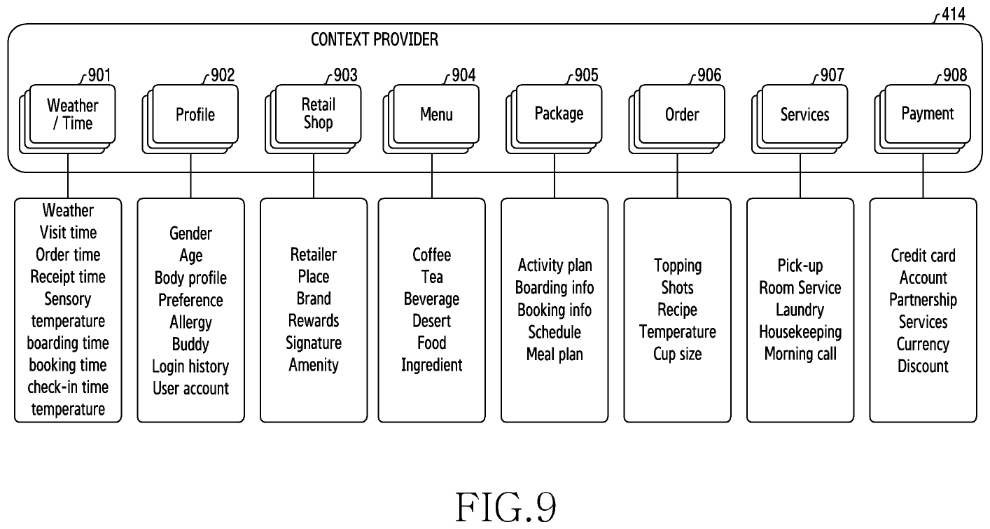

FIG. 9 illustrates an example of a plurality of categories of a context provider according to certain embodiments.

Referring to FIG. 9, the context provider 414 may include a plurality of categories. The context provider 414 may include a weather/time category 901, a profile category 902, a shop category 903, a menu category 904, a package category 905, an order category 906, a service category 907 or a payment category 908. The categories are not limited to those of FIG. 9, and the context provider 414 may include various categories which are not shown.

According to an embodiment, the weather/time category 901 may include keywords or information relating to weather, visit time, order time, receipt time, sensory temperature, boarding time, booking time, check-in time, or temperature. According to an embodiment, if the user of the electronic device 301 orders coffee, the content provider agent 420 may store the keyword relating to the weather, the visit time, the order time, the receipt time, or the sensory temperature, in the weather/time category 901. According to an embodiment, if the user of the electronic device 301 books a plane ticket, the content provider agent 420 may store the keyword relating to the boarding time or the booking time in the weather/time category 901. According to an embodiment, if the user of the electronic device 301 reserves a hotel room, the content provider agent 420 may store the keyword relating to the boarding time or the check-in time in the weather/time category 901.

According to an embodiment, the profile category 902 may store keywords or information relating to gender, age, body profile, preference, allergy, friend, user account or login history. According to an embodiment, if the user of the electronic device 301 frequently orders the same food, the content provider agent 420 may store the keyword relating to the preference in the profile category 902. According to an embodiment, the content provider agent 420 may generate at least one visual object based on the keyword stored in the profile category 902. For example, if a menu captured by the user of the electronic device 301 contains an ingredient known to cause allergies, the content provider agent 420 may generate a visual object indicating an allergy alert.

According to an embodiment, the shop category 903 may include keywords or information relating to retailer, place, brand, rewards, signature or amenity. According to an embodiment, if the user of the electronic device 301 orders coffee, the content provider agent 420 may store the keyword relating to the retailer, the place, the brand, the rewards, or the signature in the shop category 903. For example, if the user of the electronic device 301 orders mango blended which is a signature menu of the DD coffee shop located in London, the content provider agent 420 may store “London”, “DD coffee” or “mango blended” in the shop category 903.

According to an embodiment, the menu category 904 may store keywords or information relating to coffee, tea, beverage, dessert, food or ingredient. For example, if the user of the electronic device 301 orders caramel macchiato, the content provider agent 420 may store “caramel macchiato”, “caramel syrup” or “milk” in the menu category 904.

According to an embodiment, the package category 905 may store keywords or information relating to activity plan, boarding info, booking info, schedule or meal plan. According to an embodiment, if the user of the electronic device 301 receives travel plan information, the content provider agent 420 may store at least one keyword generated based on the travel plan information, in the package category 905.

According to an embodiment, the order category 906 may store keywords or information relating to topping, shots, recipe, temperature, or cup size. According to an embodiment, if the user of the electronic device 301 orders iced americano large size with two shots, the content provider agent 420 may store “large size”, “iced” or “two shots” in the order category 906.

According to an embodiment, the service category 907 may store keywords or information relating to pick-up service, room service, laundry service, housekeeping service or wake-up call service.

According to an embodiment, the payment category 908 may store keywords or information relating to credit card, account, partnership, service, currency or discount.

According to an embodiment, the content provider agent 420 may store at least one visual object based on the at least one keyword stored in the category of the context provider 414. For example, if the user of the electronic device 301 orders a pizza on a rainy day, the content provider agent 420 may generate a first visual object indicating the rain or a second visual object indicating the pizza, based on “rain” stored in the weather/time category 901 and “pizza” stored in the menu category 904. The content provider agent 420 may generate a third visual object by combining the first visual object and the second visual object.

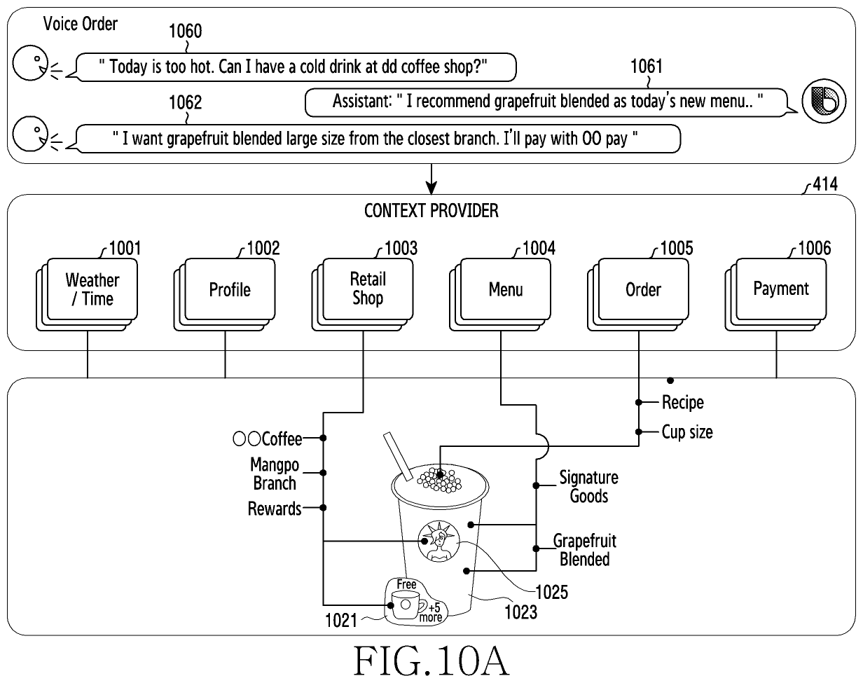

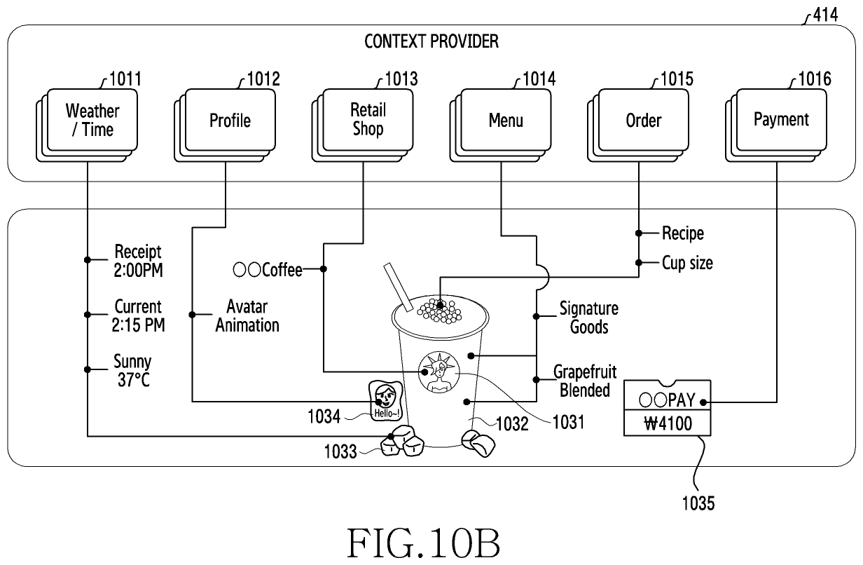

FIG. 10A and FIG. 10B illustrate an example of generating at least one visual object in an electronic device according to certain embodiments.

Referring to FIG. 10A, the processor 320 of the electronic device 301 may receive a voice signal including an utterance 1060 of “Today is too hot. Can I have a cold drink at DD coffee shop?” from the user of the electronic device 301. In response to the user's utterance 1060 (or question), the processor 320 may output a voice (or text) 1061 of “I recommend grapefruit blended as today's new menu.” through the sound output device 355. The processor 320 may receive from the user a voice signal including an utterance 1062 of “I want grapefruit blended large size from the closest brach. I'll pay with OO pay”. According to an embodiment, the processor 320 may transmit information of the voice signal including user's order information (e.g., the utterance 1062) to the server 308. Based on the received voice signal information, the content provider agent 420 of the server 308 may store at least one keyword in the categories (e.g., a weather/time category 1001, a profile category 1002, a shop category 1003, a menu category 1004, an order category 1005, or a payment category 1006) of the context provider 414. For example, the content provider agent 420 may store “OO coffee” or “Mangpo branch” in the shop category 1003. The content provider agent 420 may store “grapefruit blended” in the menu category 1004. The content provider agent 420 may store “large size” in the order category 1005. According to an embodiment, based on a user's previous order history of the electronic device 101, the content provider agent 420 may store “Offer free drink after five drinks” in the shop category 1003. The content provider agent 420 may store “signature menu” in the menu category 1004, based on identifying that the signature menu of the OO coffee is the grapefruit blended.

According to an embodiment, the content provider agent 420 may generate at least one visual object based on at least one keyword stored in the category of the context provider 414. For example, the content provider agent 420 may generate a first visual object 1025 indicating the brand logo of the OO coffee based on “OO coffee” or “Mangpo branch” of the shop category 1003. Based on “large size” of the order category 1005 or “signature menu” or “grapefruit blended” of the menu category 1004, the content provider agent 420 may generate a second visual object 1023 indicating the grapefruit blended. Based on “Offer free drink after five drinks” of the shop category 1003, the content provider agent 420 may generate a third visual object 1021 indicating that a free drink is offered for five more drinks.

According to an embodiment, the content provider agent 420 may determine a display sequence or a display position of the at least one visual object generated. For example, the content provider agent 420 may determine the display sequence or the display position of the first visual object 1025, the second visual object 1023 or the third visual object 1021.

According to an embodiment, the content provider agent 420 may receive vision information of an image including the item indicating the menu ordered by the user of the electronic device 301, from the electronic device 301. Referring to FIG. 10B, based on the vision information received from the electronic device 301 or metadata of the image, the content provider agent 420 may store at least one keyword in the categories (e.g., a weather/time category 1011, a profile category 1012, a shop category 1013, a menu category 1014, an order category 1015, or a payment category 1016) of the context provider 414. For example, the content provider agent 420 may store “receipt 2:00 PM”, “current 2:15 PM”, “sunny”, or “37°” in the weather/time category 1011.

According to an embodiment, the content provider agent 420 may receive user's payment information from the electronic device 301. Based on the received payment information, the content provider agent 420 may store at least one keyword in the category (e.g., the weather/time category 1011, the profile category 1012, the shop category 1013, the menu category 1014, the order category 1015, or the payment category 1016) of the context provider 414. For example, the content provider agent 420 may store “OO pay” or “4100 won” in the payment category 1016.

According to an embodiment, the content provider agent 420 may generate at least one visual object based on the at least one keyword stored in the category of the context provider 414. For example, the content provider agent 420 may generate a fourth visual object 1033 indicating ice cubes, based on “receipt 2:00 PM”, “current 2:15 PM”, “sunny”, or “37°” stored in the weather/time category 1011. The content provider agent 420 may generate a fifth visual object 1034 indicating the user of the electronic device 301, based on user's avatar information stored in the profile information 1012. Based on the payment information stored in the payment category 1016, the content provider agent 420 may generate a sixth visual object 1035 indicating that 4100 won is paid using OO pay.

According to an embodiment, the content provider agent 420 may determine a display sequence or a display position of the at least one visual object generated. For example, the content provider agent 420 may determine the display sequence or the display position of the generated visual objects (e.g., the first visual object 1025 through the sixth visual object 1035).

Using the server 308 associated with the electronic device 301, the electronic device 301 according to certain embodiments may receive the information processed by the server 308 and determine the display sequence and/or position of at least one visual object while displaying the image of the external object based on the received information, thus enhancing visibility of the at least one visual object.

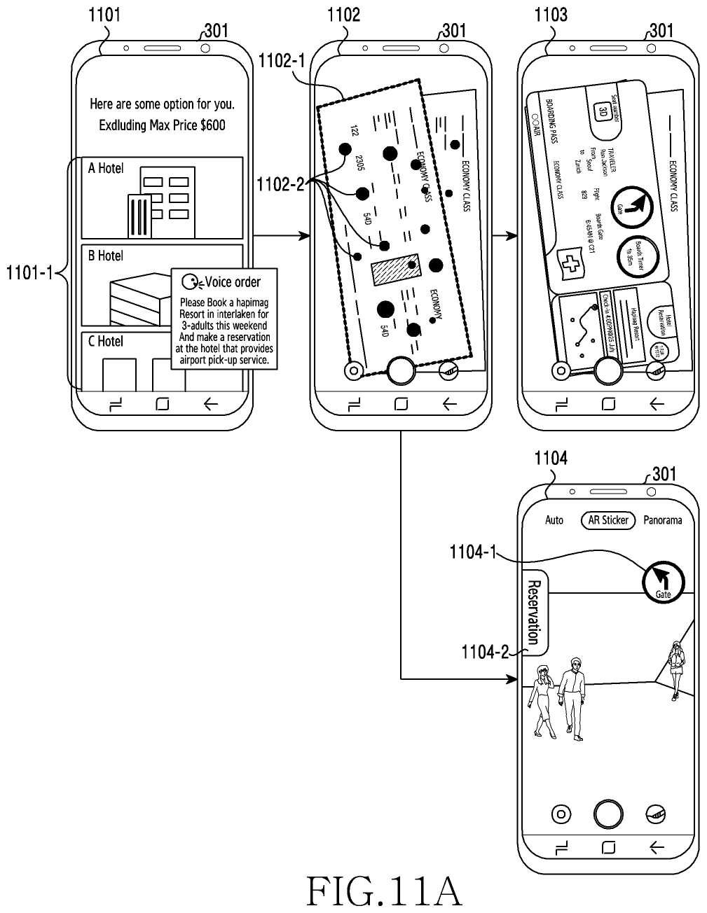

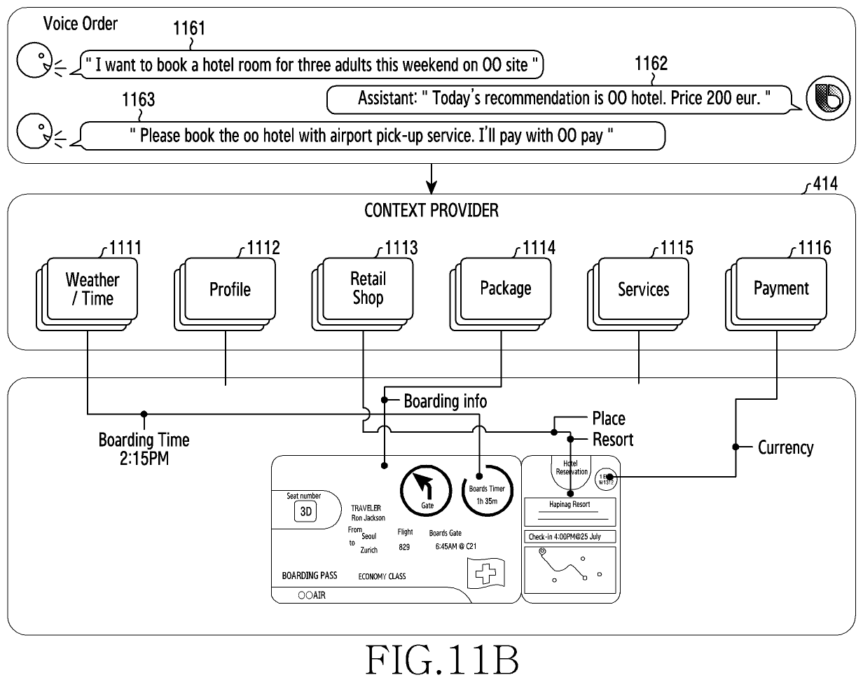

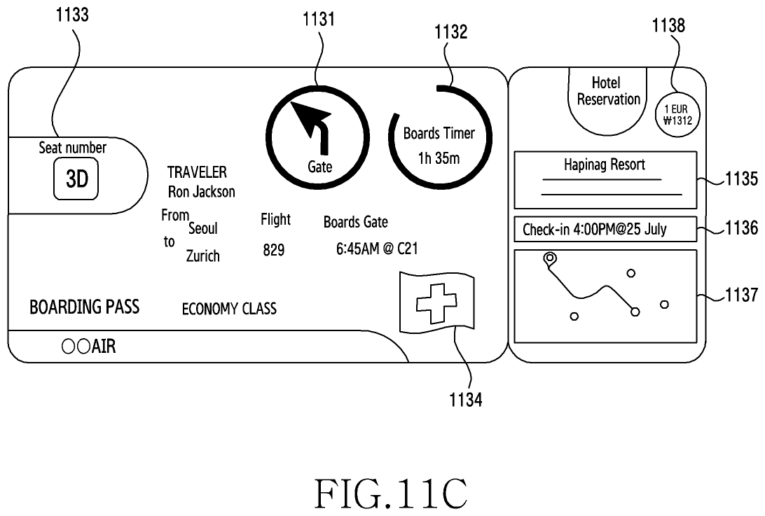

FIGS. 11A, 11B, and 11C illustrate another example of displaying at least one visual object in an electronic device according to certain embodiments.

Referring to FIGS. 11A and 11B, the processor 320 of the electronic device 301 may receive a voice signal including an utterance 1161 of “I want to book a hotel room for three adults this weekend on OO site” from the user electronic device 301. According to an embodiment, the processor 320 may output a voice 1162 (or text) of “Today's recommendation is OO hotel. Price 200 EUR.” in response to the user's utterance 1161, through the sound output device 355. According to an embodiment, the processor 320 may display information 1101-1 of the recommended hotel in a user interface 1101 of the electronic device 301. According to an embodiment, the processor 320 may receive a voice signal including an utterance 1163 of “Please book the OO hotel with airport pick-up service. I'll pay with OO pay” from the user. According to an embodiment, the processor 320 may transmit voice signal information including user's order information (e.g., the utterance 1163) to the server 308.

According to an embodiment, the content provider agent 420 of the server 308 may receive the voice signal including the user's utterance of the electronic device 301, from the electronic device 301. Referring to FIG. 11B, based on the received voice signal, the content provider agent 420 may store at least one keyword in a plurality of categories (e.g., a weather/time category 1111, a profile category 1112, a shop category 1113, a package category 1114, a service category 1115, or a payment category 1116) of the context provider 414. For example, the content provider agent 420 may store “this weekend” in the weather/time category 1111. The content provider agent 420 may store “OO hotel” or location information of the OO hotel in the shop category 1113. The content provider agent 420 may store “airport pick-up service” in the service category 1115.

According to an embodiment, after the hotel reservation information is stored in the server 308, the processor 320 may display an image including a plane ticket, as a preview image in the user interface 1102, using the camera module 380 of the electronic device 301. The processor 320 may identify an object indicating the plane ticket in the image. The processor 320 may identify vision information of an object 1102-1 indicating the plane ticket in the image. According to an embodiment, the processor 320 may superimpose and display at least one other object (e.g., a plurality of dots 1102-2) indicating that the object 1102-1 indicating the plane ticket in the image is identified. According to an embodiment, the processor 320 may identify the object 1102-1 indicating the plane ticket in the image, without displaying the at least one other object (e.g., the dots 1102-2). According to an embodiment, the processor 320 may transmit to the server 308, vision information or metadata of the at least one object 1102-1 in the image. For example, the processor 320 may transmit to the server 308, the vision information including plane boarding time, boarding gate, departure or arrival information.

According to an embodiment, based on the vision information or the metadata received from the electronic device 301, the content provider agent 420 of the server 308 may store at least one keyword in the categories (e.g., the weather/time category 1111, the profile category 1112, the shop category 1113, the package category 1114, the service category 1115, or the payment category 1116) of the context provider 414.

According to an embodiment, the content provider agent 420 may generate at least one visual object based on the at least one keyword stored in the category of the context provider 414. Referring to FIG. 11C, for example, the content provider agent 420 may generate a visual object 1131 indicating a direction to the boarding gate based on information of the boarding gate and current location. The content provider agent 420 may generate a visual object 1132 indicating a remaining time to the boarding based on a boarding time and a current time. The content provider agent 420 may generate a visual object 1133 indicating a seat number based on a plan seat number. The content provider agent 420 may generate a visual object 1134 indicating a flag of a country of the arrival based on the arrival. The content provider agent 420 may generate a visual object 1135 indicating hotel information based on the hotel reservation information. The content provider agent 420 may generate a visual object 1136 indicating the check-in time based on the hotel reservation information. The content provider agent 420 may generate a visual object 1137 indicating a way from the airport to the hotel based on the hotel reservation information. The content provider agent 420 may generate a visual object 1138 indicating a current exchange rate based on current exchange rate information. According to an embodiment, the content provider agent 420 may transmit the generated at least one visual object (e.g., the visual object 1131 through the visual object 1138) to the electronic device 301.

According to an embodiment, the processor 320 may receive at least one visual object (e.g., the visual object 1131 through the visual object 1138) from the server 308. Referring back to FIG. 11A, the processor 320 may display the at least one visual object (e.g., the visual object 1131 through the visual object 1138 of FIG. 11C) to be superimposed on the image including at least one object, in the user interface 1103. According to an embodiment, the processor 320 may change and display part of the at least one visual object according to the time or the place of the electronic device 301. For example, the processor 320 may change and display the visual object 1131 indicating the direction to the boarding gate, according to the current location of the electronic device 301. For example, the processor 320 may change and display the visual object 1132 indicating the remaining boarding time, based on time.

According to an embodiment, the processor 320 may display at least one visual object even if at least one object is not recognized in the image. For example, the processor 320 may identify that the current location of the electronic device 301 is the airport and is not the boarding gate. The processor 320 may display a visual object 1104-1 (e.g., the visual object 1131 of FIG. 11C) for guiding the user to the boarding gate, in the user interface 1104. According to an embodiment, the processor 320 may display a visual object 1104-2 indicating the plane and hotel reservation information, based on identifying that the current location of the electronic device 301 is the airport. According to an embodiment, the processor 320 may display the plane and hotel reservation information, based on a user input to the visual object 1112.

As such, the electronic device 301 according to certain embodiments may provide an appropriate service for a user's situation, by displaying the visual object which is displayed with the image of the external object as associated with the server 308 and updated according to the user's current status.

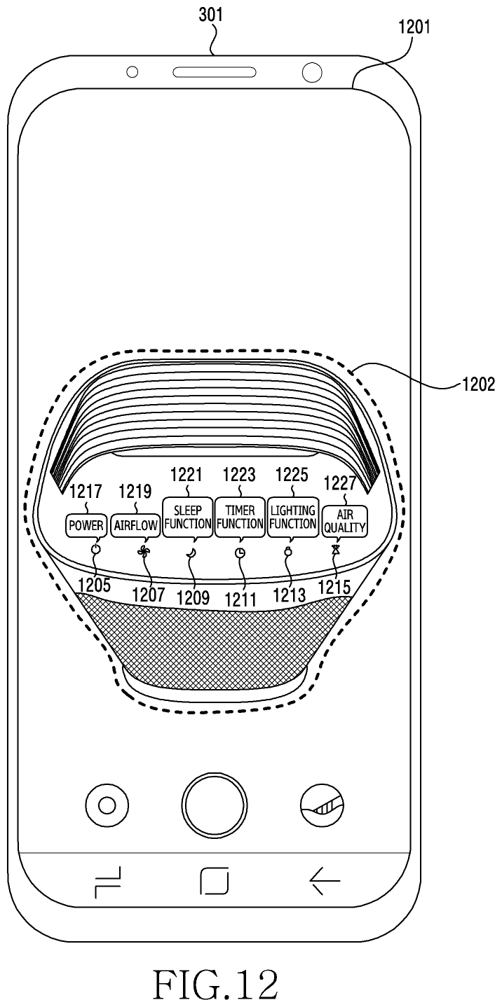

FIG. 12 illustrates yet another example of a user interface of an electronic device according to certain embodiments.

Referring to FIG. 12, the processor 320 may display an image including an object 1202 indicating an internet of things (IoT) device, in a user interface 1201 of an application using the camera module 380. In certain embodiments, the IoT device may be purchased using the electronic device 301. In certain embodiments, the IoT device may be registered in the electronic device 301 or a server related to the electronic device 301, using a user account corresponding to a user account of the electronic device 301. In certain embodiments, the application may provide an IoT service. In certain embodiments, the application may indicate an application authorized to use the camera module 380. In certain embodiments, the application may provide the association between the IoT device and the electronic device 301.

In certain embodiments, the processor 320 may obtain information of visual objects 1217, 1219, 1221, 1223, 1225, and 1227 related to executable objects 1205, 1207, 1209, 1211, 1213, and 1215 respectively, from the object 1202 of the image. In certain embodiments, the visual objects 1217, 1219, 1221, 1223, 1225, and 1227 may be guide information for the executable objects 1205, 1207, 1209, 1211, 1213, and 1215 respectively.

For example, the processor 320 may transmit the image information to the server 308. Based on the image information, the server 308 may extract the executable objects 1205, 1207, 1209, 1211, 1213, and 1215 from the object 1202. The server 308 may acquire the visual objects 1217, 1219, 1221, 1223, 1225, and 1227 related to the extracted executable objects 1205, 1207, 1209, 1211, 1213, and 1215. For example, the server 308 may obtain the visual object 1217 indicating that the executable object 1205 controls power of the IoT device, the visual object 1219 indicating that the executable object 1207 controls airflow outputted from the IoT device, the visual object 1221 indicating that the executable object 1209 activates a sleep mode of the IoT device, the visual object 1223 indicating that the executable object 1211 sets a timer function of the IoT device, the visual object 1225 indicating that the executable object 1213 activates a lighting function of the IoT device, and the visual object 1227 indicating that the executable object 1215 shows the purified air quality of the IoT device. The server 308 may transmit the information of the visual objects 1217, 1219, 1221, 1223, 1225, and 1227 to the electronic device 301.

In certain embodiments, based on the received information, the processor 320 may display the visual objects 1217, 1219, 1221, 1223, 1225, and 1227, as superimposed on the displayed object 1202. For example, the processor 320 may display the visual object 1217 near the executable object 1205 to associate the visual object 1217 with the executable object 1205, display the visual object 1219 near the executable object 1207 to associate the visual object 1219 with the executable object 1207, display the visual object 1221 near the executable object 1209 to associate the visual object 1221 with the executable object 1209, display the visual object 1223 near the executable object 1211 to associate the visual object 1223 with the executable object 1211, display the visual object 1225 near the executable object 1213 to associate the visual object 1225 with the executable object 1213, and display the visual object 1227 near the executable object 1215 to associate the visual object 1227 with the executable object 1215.

While the visual objects 1217, 1219, 1221, 1223, 1225, and 1227 are the texts in FIG. 12, at least part of the visual objects 1217, 1219, 1221, 1223, 1225, and 1227 may be configured in a different format. For example, the visual objects 1217, 1219, 1221, 1223, 1225, and 1227 may be configured as animations, videos, symbols, or their combination.

In certain embodiments, the electronic device 301 may provide the enhanced user experience, by recognizing the IoT device related to the electronic device 301 in the image acquired by the camera module 380 and providing the guide information for the extracted IoT device.

As above, a method of an electronic device according to certain embodiments may include transmitting information of a purchased item in relation to the electronic device, to a server, after transmitting the item information, displaying an image acquired using a camera of the electronic device, on a display of the electronic device, transmitting information of the image to the server, based on identifying at the server that at least one object in the image corresponds to the item, receiving at least one visual object information from the server using a communication circuit of the electronic device, and displaying the at least one visual object superimposed on the image to associate the at least one object with the at least one visual object, on a display of the electronic device.

In certain embodiments, the at least one object may be covered by superimposing the at least one visual object at least in part.

In certain embodiments, the method may further include, while transmitting the image information and receiving the at least one visual object information, displaying a visual effect to indicate transmission of the image information and reception of the at least one visual object information, on a preview image.

In certain embodiments, the method may further include, in response to receiving a voice signal for ordering the item from a user of the electronic device, providing a service for purchasing the item, and based on providing the service, changing the display of the at least one visual object, or changing the at least one visual object to other visual object. In certain embodiments, the method may further include transmitting a voice signal relating to the item order to the server, to identify and store at least one keyword in the server based at least in part on the voice signal for the item order. In certain embodiments, the at least one visual object may be generated at the server based at least in part on the at least one keyword, at least one object in the image, or metadata of the image.

In certain embodiments, the method may further include, based at least in part on the at least one object in the image, determining a display position or a display sequence of the at least one visual object.

In certain embodiments, the method may further include, changing the at least one visual object based at least in part on time, a place of the electronic device or information of other electronic device connected to the electronic device.

An electronic device according to certain embodiments may provide at least one visual object related to at least one object in an image.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. An electronic device comprising:
a camera;
a communication circuit;
a display;
a processor operatively coupled with the camera, the communication circuit, and the display; and
a memory operatively coupled with the processor,
wherein the memory stores instructions, when executed, causing the processor to,
transmit information of an item purchased with the electronic device, to a server using the communication circuit,
after transmitting the item information, display an image acquired using the camera, on the display,
transmit at least a portion of the image to the server using the communication circuit, and
superimpose at least one visual object received from the server on the image to associate the at least one object with the at least one visual object, on the display when the server identifies at least one object in the image corresponds to the purchased item.

2. The electronic device of claim 1, wherein the at least one object in the image is at least partially covered by the at least one visual object.

3. The electronic device of claim 1, wherein the instructions cause the processor to,
while receiving the at least one visual object information, display a visual effect to indicate transmission of the at least the portion of the image and reception of the at least one visual object information, on the image.

4. The electronic device of claim 1, wherein the instructions cause the processor to,
in response to receiving a voice signal relating to an order of the item from a user of the electronic device, open an application for purchasing the item, and
based on the application, change the display of the at least one visual object, or change the at least one visual object to another visual object.

5. The electronic device of claim 4, wherein the instructions cause the processor to,
transmit a voice signal relating to the item order to the server.

6. The electronic device of claim 1, wherein the item is purchased by receiving a voice command from a user.

7. The electronic device of claim 1, wherein the instructions cause the processor to,
based at least in part on the at least one object in the image, determine a display position or a display sequence of the at least one visual object.

8. The electronic device of claim 1, wherein the instructions cause the processor to,
change the at least one visual object based at least in part on time, a place of the electronic device or another electronic device connected to the electronic device.

9. A method of an electronic device, comprising:
transmitting information of an item purchased using the electronic device, to a server;
after transmitting the item information, displaying an image acquired using a camera of the electronic device, on a display of the electronic device;
transmitting at least portion of the image to the server; and
superimposing at least one visual object received from the server on the image to associate the at least one object with the at least one visual object, on the display of the electronic device.

10. The method of claim 9, wherein the at least one object is at least partially covered by the at least one visual object.

11. The method of claim 9, further comprising:
while transmitting the image information and receiving the at least one visual object information, displaying a visual effect to indicate transmission of at least p of the image and reception of the at least one visual object information, on a preview image.

12. The method of claim 9, further comprising:
in response to receiving a voice signal for ordering the item from a user of the electronic device, opening an application for purchasing the item; and
based on the application, changing the display of the at least one visual object, or changing the at least one visual object to other visual object.

13. The method of claim 12, further comprising:
transmitting a voice signal for the item order to the server, to identify and store at least one keyword in the server based at least in part on the voice signal for the item order.

14. The method of claim 13, wherein the at least one visual object is generated at the server based at least in part on the at least one keyword, at least one object in the image, or metadata of the image.

15. The method of claim 9, further comprising:
based at least in part on the at least one object in the image, determining a display position or a display sequence of the at least one visual object.

16. The method of claim 9, further comprising:
changing the at least one visual object based at least in part on time, a place of the electronic device or information of other electronic device connected to the electronic device.

17. An electronic device comprising:
a camera;
a display;
a processor operatively coupled with the camera and the display; and
a memory operatively coupled with the processor,
wherein the memory stores instructions, when executed, causing the processor to,
store information of a purchased item in relation to the electronic device, in the memory,
after storing the item information, display an image acquired using the camera, as a preview image on the display,
identify that at least one object in the image corresponds to the item,
based on identifying that the at least one object in the image corresponds to the item, obtain information of at least one visual object, and
display the at least one visual object superimposed on the image associating the at least one object with the at least one visual object, on the display.

18. The electronic device of claim 17, wherein the purchased item information comprises information of at least one keyword related to the purchased item.

19. The electronic device of claim 17, wherein the at least one object is covered by the at least one visual object.

20. The electronic device of claim 17, wherein the instructions cause the processor to,
change the at least one visual object based on time or a place.
